(19) United States
(12) Patent Application Publication
(10) Pub. No.: US 2025/0020332 A1
(43) Pub. Date: Jan. 16, 2025

(54) HEAT PUMP/AIR PURIFICATION SYSTEM WITH ORNAMENTAL FIREPLACE ENCLOSURE

(71) Applicant: Clean Flame Thermal Solutions, LLC, Cape Neddick, ME (US)

(72) Inventor: Michele Putko, Cape Neddick, ME (US)

(21) Appl. No.: 18/897,743

(22) Filed: Sep. 26, 2024

Related U.S. Application Data
(60) Provisional application No. 63/585,536, filed on Sep. 26, 2023.

(51) Int. Cl. F24C 7/00; F21S 10/04; F24C 15/06; F24F 5/00; F24F 8/108; F24F 13/08

(52) U.S. Cl. CPC F24C 7/004; F24C 15/06; F24F 5/0096; F24F 8/108; F21S 10/043; F24F 13/081

(57) ABSTRACT

Provided herein are heat pump air purification systems including a vertically oriented indoor unit having a supply air outlet and a return air inlet, a floor stand positioned under the indoor unit, wall brackets attachable to the indoor unit and to a wall, a supply air elbow to redirect a supply airflow exiting the supply air outlet, an auto louver in fluid communication with the elbow, a return air duct in fluid communication with the inlet, a filter positioned in the duct, an integration frame including vertical posts, horizontal supports between the vertical posts defining frame apertures, arms extending outward from the vertical posts, and wall mounts for securing the integration frame to the wall, a flame box mountable to the integration frame, a trim plate attachable to the integration frame, decorative surround elements attachable to the integration frame, and a fireplace cabinet.

### CROSS REFERENCE TO RELATED APPLICATIONS

This application claims benefit under 35 U.S.C. § 119 (e) of U.S. Provisional Application No. 62/585,536, filed on 26 Sep. 2023, entitled “Heat Pump/Air Purification System with Ornamental Fireplace Enclosure,” the entirety of which is incorporated by reference herein.

### BACKGROUND

Air source heat pump (ASHP) technology provides an economical, low carbon, highly efficient method of heating and cooling. Air source heat pumps exist in several sizes (heating and cooling capacities) and configurations to include ducted and ductless. Despite the numerous configurations, none have high aesthetic appeal. Rather, they are either concealed (ducted configurations) or designed to blend in with the surroundings (ductless configurations). A ducted air source heat pump indoor unit is typically concealed in an attic, basement, closet, or utility room. Although this configuration is a prevalent method of addressing the problem of undesirable heat pump aesthetics, it often entails duct design and installation which is complex, expensive, and detracts from the efficiency of the system. There are also physical constraints with ducted systems which often prevent their installation.

Due to the cost, complexity, and reduced efficiency of ducted systems, many heating, ventilation and air-conditioning (HVAC) companies will steer consumers away from this configuration in favor of the ductless mini-split system. Such systems have become quite popular, with ductless heat pumps representing 80-90+% of the ASHP market in the U.S. Northeast region for more than 10 years.

Such ductless mini-split systems are available in many configurations, including wall, floor, and ceiling mounted systems. Each of these configurations attempt to minimize the obtrusive nature of the indoor units such that they blend in with the surroundings. Nevertheless, despite the variety of configurations, the aesthetics of the systems do not appeal to many consumers.

Conversely, fireplaces are not hidden or designed to blend in with the surroundings. Instead, fireplaces often serve as focal points in a room and are designed to be both aesthetically pleasing and functional. From intricate carvings to sleek designs, a fireplace can reflect a wide range of artistic styles. Fireplaces are appreciated as both a functional element for heat, as well as a piece of art.

Unfortunately, when used for heating, combustion fireplaces are inefficient and highly polluting. All combustion fireplaces (wood, wood products or fossil fuel) emit greenhouse gasses as well as other harmful products. The products of combustion are vented to the outside air resulting in a highly polluting and inefficient system.

Non-combusting fireplaces having a simulated flame and electric resistance heating do not produce onsite products of combustion. However, due to the carbon intensity of the U.S. electric grid, electric resistance heating is often more carbon intensive and more expensive than other traditional heating methods. Electric resistance fireplaces also have low heating capacities, (˜1500 W—equivalent to an electric space heater) making them only suitable for supplemental or small room heating.

Nevertheless, despite the environmental and performance drawbacks of the various fireplace configurations, they remain very popular housing features.

### SUMMARY

The present technology combines the functionality and efficiency of a mini-split heat pump with the aesthetics of a fireplace by providing heat pump/air purification systems having an ornamental fireplace enclosure. Advantageously, such systems are also provided using components which facilitate easy assembly, installation, and maintenance of the system. In particular, the system is configured to look like a fireplace, yet provides highly efficient heating, cooling, and dehumidification characteristic of a mini split heat pump system contained within the ornamental enclosure. The system also includes an advanced air purification filter, in addition to the standard heat pump air filter, to provide improved air quality.

In one aspect, a heat pump air purification system is provided. The system includes a slim duct indoor unit heat exchanger (indoor unit) positioned vertically, wherein a supply air outlet of the indoor unit is positioned above a return air inlet of the indoor unit. The system also includes a floor stand positioned underneath the indoor unit in contact with a floor. The system also includes upper and lower wall brackets attachable to one or more mounting tabs of the indoor unit and to a wall. The system also includes a supply air elbow in fluid communication with the supply air outlet and positioned to redirect a supply airflow exiting the supply air outlet. The system also includes an auto louver in fluid communication with the elbow for steering a directionality of the supply airflow exiting the heat pump air purification system. The system also includes a return air duct in fluid communication with the return air inlet. The system also includes an air filter positioned in the return air duct for filtering a return airflow. The system also includes an integration frame. The integration frame includes first and second vertical posts. The integration frame also includes a plurality of horizontal supports extending between the vertical posts and, with the vertical posts, defining a supply air frame aperture, a return air frame aperture, and a flame box frame aperture. The integration frame also includes horizontally opposed upper and lower arms extending outward in parallel from each of the vertical posts. The integration frame also includes upper and lower wall mounts for securing the integration frame to the wall. The system also includes a flame box mountable to the integration frame. The system also includes a trim plate including a supply air trim aperture, a return air trim aperture, and a flame box trim aperture, the trim plate removably attachable to a front surface of the integration frame. The system also includes first and second decorative vertical surround elements attachable to the front surface of the integration frame. The system also includes a horizontal surround element attachable to the front surface of the integration frame. The system also includes a fireplace cabinet having a front surface sized and shaped to partially overlap a front surface of the vertical and horizontal surrounds, an upper surface extending between the front surface and the wall, and opposing side surfaces extending between the front surface and the wall.

In some embodiments, the system also includes a magnetic grill attachable to the trim plate positioned to at least partially cover the return air trim and frame apertures. In some embodiments, the floor stand includes a stand frame comprising opposing end rails and opposing side rails attached to the opposing end rails, the stand frame having upper and lower surfaces. In some embodiments, the floor stand includes a plurality of feet extending from the lower surface of the stand frame. In some embodiments, each of the plurality of feet of the floor stand is height-adjustable with respect to the stand frame to permit leveling of the floor stand. In some embodiments, the system also includes a plurality of vibration dampening pads positioned on the upper surface of the stand frame for contact with a bottom surface of the indoor unit. In some embodiments, the upper and lower wall brackets each include opposing wall attachment slots to permit variable horizontal positioning of one or more fasteners used to attach the brackets to the wall. In some embodiments, the system also includes vibration dampening fasteners for attachment of the upper and lower wall brackets to the one or more mounting tabs of the indoor unit. In some embodiments, the lower wall bracket also includes a floor stand attachment tab for attachment to the floor stand. In some embodiments, the upper and lower wall mounts are hingedly attached to the horizontally opposed upper and lower arms of the integration frame.

In some embodiments, the air filter also includes a filter frame and a pleated filter media positioned in the filter frame. In some embodiments, a pressure drop of the air filter is 0.25 in WC or less. In some embodiments, the system also includes a turning baffle positioned inside the supply air elbow to redirect the supply airflow exiting the supply air outlet. In some embodiments, the auto louver includes a plurality of movable vanes configured to steer at least one of a vertical directionality of the supply airflow, a horizontal directionality of the supply airflow, or combinations thereof. In some embodiments, the flame box is an LED display. In some embodiments, the integration frame includes at least one quick attachment mechanism for removably attaching one or more of the trim plate, the vertical surrounds, and the horizontal surround, the quick attachment mechanism including one or more of tabs, magnets, hook and loop fasteners, detents, clips, or combinations thereof. In some embodiments, the integration frame includes at least one trim tab sized and shaped to engage and removably attach to the trim plate. In some embodiments, a rear surface the trim plate and at least one of the front surface of the integration frame or flanges of the flame box include at least one quick attachment mechanism including one or more of magnets, hook and loop fasteners, detents, clips, or combinations thereof for attachment of the trim plate to the integration frame and/or the flanges of the flame box. In some embodiments, the horizontally opposed upper and lower arms of the integration frame each include at least one vertical surround tab sized and shaped to engage and removably attach to a corresponding one of the vertical surround elements. In some embodiments, a rear surface of each vertical and/or horizontal surround element and the front surface of the integration frame include at least one quick attachment mechanism including one or more of magnets, hook and loop fasteners, detents, clips, or combinations thereof for attachment of the vertical and/or horizontal surround elements to the integration frame. In some embodiments, the horizontally opposed upper arms of the integration frame and/or the vertical posts of the integration frame include at least one horizontal surround tab sized and shaped to engage and removably attach to the horizontal surround element.

In another aspect, a foldable duct elbow is provided. The foldable duct elbow includes first and second rectangular outer elbow wall elements foldably attached along a shared side and having opposing non-shared sides. The foldable duct elbow also includes four side elbow wall elements, each having a long end foldably attached to and coextensive with an end of one of the first and second outer elbow wall elements, a short end opposite the long end, an angled side extending from a corner of the attached outer elbow wall element on the shared side toward the short side of the side elbow wall element, and a straight side extending from a non-shared corner along the non-shared side of the attached outer elbow wall element. The foldable duct elbow also includes a first rectangular inner elbow wall element having an attached end foldably attached to the short side of a first one of the side elbow wall elements, wherein the first one of the side elbow wall elements is attached to a first end of the first rectangular outer elbow wall element. The foldable duct elbow also includes a second rectangular inner elbow wall element having an attached end foldably attached to the short side of a second one of the side elbow wall elements, wherein the second one of the side elbow wall elements is attached to a first end of the second rectangular outer elbow wall element such that the first and second inner elbow wall elements are positioned coextensively, spaced apart, and in parallel. The foldable duct elbow also includes wherein folding the first inner elbow wall element along the attached end, folding the first inner elbow wall element along the long end, and folding a third side elbow wall element along the long end attached to a second end of the first rectangular outer wall element brings a free end of the first inner elbow wall element into contact with the short side of the third side elbow wall element for attachment thereto to form a first flowpath. The foldable duct elbow also includes wherein folding the second inner elbow wall element along the attached end, folding the second inner elbow wall element along the long end, and folding a fourth side elbow wall element along the long end attached to a second end of the second rectangular outer wall element brings a free end of the second inner elbow wall element into contact with the short side of the fourth side elbow wall element for attachment thereto to form a second flowpath. The foldable duct elbow also includes wherein the first and second flowpaths are foldable along the shared side of the first and second rectangular outer elbow wall elements to bring the angled sides of the first and second side elbow wall elements into contact, the angled sides of the third and fourth side elbow wall elements into contact, and inner sides of the first and second inner elbow wall elements into contact for attachment therebetween to form a folded configuration of the foldable duct elbow.

In some embodiments, the shared side, each of the long ends, each of the short ends, each of the attached ends, each of the free ends, and each of the inner sides includes an angled chamfer to restrict geometry of the folded configuration to a desired shape of the foldable duct elbow. In some embodiments, the foldable duct elbow also includes a turning baffle attached within the foldable duct elbow and positioned to redirect air flowing therein.

In yet another aspect, a method for assembling a heat pump air purification system is provided. The method includes positioning the indoor unit on the floor stand. The method also includes leveling the indoor unit by adjusting leveling legs of the floor stand. The method also includes attaching the upper and lower wall brackets to the mounting tabs of the indoor unit. The method also includes fastening the lower wall bracket to the floor stand by a floor stand attachment tab of the lower wall bracket. The method also includes attaching the upper and lower wall brackets to the wall. The method also includes connecting the supply air elbow to the supply air outlet of the indoor unit. The method also includes inserting an auto louver bracket into an outlet of the supply air elbow. The method also includes attaching the air return duct to the return air inlet of the indoor unit. The method also includes aligning the integration frame with the indoor unit, the supply air elbow outlet, and the air return duct. The method also includes mounting the integration frame to the wall. The method also includes inserting the flame box into the flame box frame aperture of the integration frame and attach the flame box to the integration frame. The method also includes inserting and attaching the auto louver to the auto louver bracket in the outlet of the supply air elbow. The method also includes electrically connecting the auto louver to the indoor unit. The method also includes sliding the trim plate onto the integration frame by inserting one or more trim tabs of the integration frame into the trim plate and pressing the trim plate against the integration frame to engage at least one quick attachment mechanism including one or more of magnets, hook and loop fasteners, detents, clips, or combinations thereof positioned on a rear surface of the trim plate and/or a front surface of the integration frame. The method also includes sliding the vertical surrounds onto the integration frame by inserting one or more vertical surround tabs of the integration frame into the vertical surrounds and pressing the vertical surrounds against the integration frame to engage at least one quick attachment mechanism including one or more of magnets, hook and loop fasteners, detents, clips, or combinations thereof positioned on a rear surface of the vertical surrounds and/or a front surface of the integration frame. The method also includes sliding the horizontal surround onto the integration frame by inserting one or more horizontal surround tabs of the integration frame into the horizontal surround and pressing the horizontal surround against the integration frame to engage at least one quick attachment mechanism including one or more of magnets, hook and loop fasteners, detents, clips, or combinations thereof positioned on a rear surface of the horizontal surround and/or a front surface of the integration frame. The method also includes positioning the fireplace cabinet around the integration frame and the vertical and horizontal surrounds and attach the fireplace cabinet to the wall. The method also includes inserting the air filter into the return air duct. The method also includes covering the air filter with a magnetic grill inserted through the return air frame and trim apertures.

### BRIEF DESCRIPTION OF THE DRAWINGS

FIG. 1A is an isometric view of a heat pump/air purification system having an ornamental fireplace enclosure in accordance with various embodiments.

FIG. 1B is a partially exploded view of the heat pump/air purification system having an ornamental fireplace enclosure in accordance with various embodiments.

FIGS. 2A-2B are side and front views of a vertically oriented heat pump indoor unit in accordance with various embodiments.

FIGS. 3A-3B are isometric and exploded views of a floor stand in accordance with various embodiments.

FIGS. 4A-4B are isometric and rear views of an upper wall bracket in accordance with various embodiments.

FIGS. 4C-4D are isometric and rear views of a lower wall bracket in accordance with various embodiments.

FIGS. 5A-5F illustrate a foldable supply air quick assemble elbow in accordance with various embodiments.

FIG. 6A is a perspective view of a return air duct in accordance with various embodiments.

FIG. 6B is a perspective view of a return air filter in accordance with various embodiments.

FIGS. 6C-6D are a perspective view and a side view of the return air filter of FIG. 6B aligned for insertion into the return air duct of FIG. 6A.

FIG. 6E is a perspective view of a magnetic grill in accordance with various embodiments.

FIG. 6F is an exploded view of an assembly of the magnetic grill of FIG. 6E, the return air filter of FIG. 6B, and the return air duct of FIG. 6A.

FIGS. 7A-7B are an exploded view and a perspective view of an integration frame in accordance with various embodiments.

FIG. 8 illustrates a flame box in accordance with various embodiments.

FIG. 9A illustrates a perspective view of an auto louver in accordance with various embodiments.

FIG. 9B illustrates a perspective view of a louver bracket in accordance with various embodiments.

FIGS. 9C-9D illustrate vertical and horizontal redirection of an airflow by the auto louver of FIG. 9A.

FIG. 10 illustrates a perspective view of a trim plate in accordance with various embodiments.

FIG. 11 illustrates a perspective view of ornamental vertical and horizontal surrounds in accordance with various embodiments.

FIGS. 12A-12B illustrate side and front perspective views of a fireplace cabinet in accordance with various embodiments.

FIGS. 13A-13Z illustrate assembly steps for assembling the heat pump/air purification system having an ornamental fireplace enclosure of FIG. 1A.

### DETAILED DESCRIPTION

Provided herein are heat pump/air purification systems having an ornamental fireplace enclosure, which combines the functionality and efficiency of a mini-split heat pump with the aesthetics of a fireplace. In some embodiments, the systems provided herein have been achieved by modifying ducted heating, cooling, dehumidification, and air purification systems typically found in a basements, attics, or utility closets into “short duct” systems so that the conditioned/purified air can be delivered directly to the conditioned space. As explained in further detail below, these modifications are made much more practical by the development of a short duct air supply having a vaned elbow capable of turning the supply air in a confined space with low pressure drop and the provision of a short duct return having a deep air filter capable of filtering the air at a high level with a very low pressure drop, allowing the system to maintain heating, cooling, and energy efficiency despite its compact form. In addition, the systems are designed and configured to facilitate rapid assembly and quick installation.

Furthermore, the systems include elements for producing an aesthetically pleasing façade, which enables the invention to be positioned in a prominent area and increases the probability of satisfying the heating and cooling needs of a home with an energy efficient heating and cooling system, whether as a single point source or as part of a multi-zone heat pump system having multiple indoor units or “heads” sharing an outdoor unit.

In more detail, single point source heating is a common method of heating most frequently used in smaller homes. Traditionally a woodstove, pellet stove or direct vent space heater is used for single point source heating. These solutions work best in small, well-insulated homes with open floor plans. In this regard, although a traditional mini-split heat pump system can be used as a single point source, the systems described herein are an ideal solution for single point source for heating, cooling, dehumidification, and air filtration because the systems provided herein are aesthetically pleasing, accessibly placed on the floor and low on the wall, and have a compact form factor. Furthermore, although the systems described herein are very well suited for single point source use, they are also compatible with a multi-zone heat pump system, whether the other heads are conventional indoor units or additional instances of the systems provided herein.

The heating, cooling and dehumidification of the systems described herein are achieved by a heat pump system. Specifically, a “mini-split” or “multi-split” heat pump system. In general, mini-splits or multi-splits include one or more indoor units for cooling the air in the room where they are located. The indoor units are connected by electrical power and refrigerant lines to one or more outdoor units. More generally, the “split” configuration permits the indoor unit to be installed within the ornamental enclosure and connected to a corresponding outdoor unit in accordance with manufacturer's directions.

As shown and described herein, the present technology uses a vertically mounted slim duct system for the indoor unit because such systems were found to best fit the spatial footprint of a traditional fireplace. In particular, the vertically mounted configuration of the indoor unit allows the unit to fit within a rectangular enclosure providing the aesthetic of a fireplace and the slim duct system allows the heat pump to connect with short air return and air supply ducts while still fitting within the enclosure, promotes efficient and quiet operation and provides an aesthetically pleasing appearance.

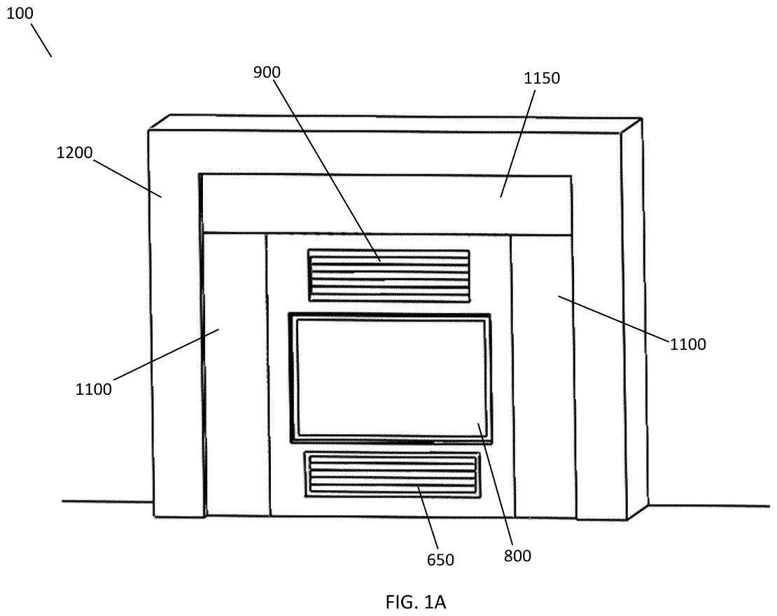

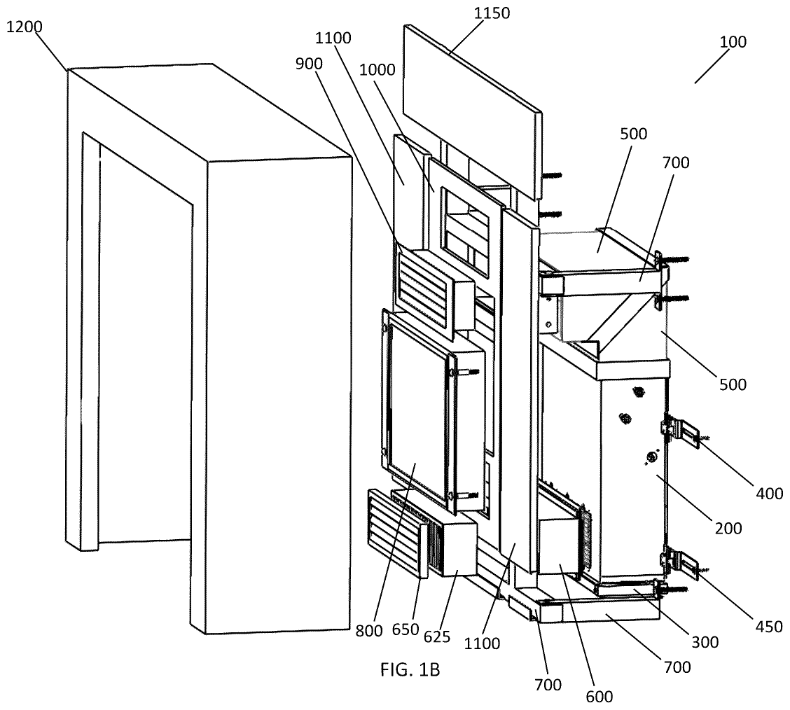

Referring now to FIGS. 1A-1B, a heat pump/air purification system having an ornamental fireplace enclosure 100 (hereinafter the “system 100”) includes a vertically oriented slim-duct heat pump indoor unit 200 to provide heating, cooling, and dehumidification. The system 100 also includes a levelable floor stand 300 on which the indoor unit 200 is positioned for providing support and vibration dampening for the indoor unit 200 with respect to the floor while also and facilitating easy leveling during installation. The indoor unit 200 is securable to the wall via one or more upper wall brackets 400 and lower wall brackets 450 attached on a rear side thereof. In some embodiments, the lower wall brackets 450 can also be securable to a rear side of the floor stand 300 for further safety and stability of the system 100.

Because airflow exiting the indoor unit 200 (“supply air”) is oriented vertically, a supply air elbow 500 is positioned atop the indoor unit 200 at its outlet for turning the supply air toward a front of the system 100 for egress into the room in which the system is installed. In order to provide directional control over the supply air exiting the supply air elbow 500, the system 100 can include an auto louver 900 in an outlet thereof. In order to provide filtration of airflow entering the indoor unit 200 from the room (“return air”), a return air duct 600 can be attached at an inlet of the indoor unit 200 and an air filter 625 can be installed therein. In some embodiments an ornamental grill 650 can be included to protect the filter 625 and improve its aesthetic appearance.

The system 100 also includes an integration frame 700 to secure, support, and align the various aesthetic and functional elements of the system 100. The integration frame 700 is generally positioned in front of the functional components such as the indoor unit 200, floor stand 300, upper and lower brackets 400, 450, elbow 500, and duct 600 with frame apertures so as not to restrict return and supply airflow, and is securable to the wall via upper and lower wall mounts which are connected to and extend substantially perpendicular to upper and lower arms of the integration frame 700.

Several ornamental features of the system 100 are assemblable to the integration frame 700 including a trim plate 1000 having apertures through which the auto louvers 900, grill 650, and a flame box 800 configured to simulate the appearance of a flame are installed and assembled to the integration frame 700. Two vertical surrounds 1100 are assembled to the frame 700 adjacent to the trim plate 1000 on each side thereof and a horizontal surround 1150 is assemblable to the frame 700 across a top of each of the trim plate 1000 and the two vertical surrounds 1100.

The system 100 can then be ornamentally retained within a fireplace cabinet 1200 to provide a cohesive, aesthetically pleasing appearance. The fireplace cabinet 1200 includes vertical sides, an upper surface, a fully open back, and a partially open front wherein a front surface extends inward from the vertical sides and upper surface to provide rigidity to the cabinet 1200 and to partially overlap the vertical surrounds 1100 and the horizontal surround 1150. Thus, when the cabinet 1200 is installed over the rest of the system 100, only the aesthetically pleasing elements such as the vertical surrounds 1100, the horizontal surrounds 1150, the trim plate 1000, the flame box 800, the grill 650, and the auto louvers 900 remain visible. In some embodiments, the fireplace cabinet 1200 can preferably be mounted to the wall for safety and stability.

In use, return air enters the system 100 through the return grille 650, is filtered in the return air duct 600 by the filter 625, is conditioned in the heat pump indoor unit 200, is reoriented back into the room by the elbow 500 and exits back into the room through the auto louvers 900.

It should be noted that, although shown and described herein as being installed on an exterior or interior wall of a room in a cabinet structure (e.g., fireplace cabinet 1200), the system 100 can, in some embodiments, also be installed or built into a recess in a wall similar to a conventional fireplace. In such embodiments, the vertical and horizontal surrounds 1100, 1150 and the trim plate will be substantially flush with the wall. In such embodiments, the wall brackets 400, 450 and the integration frame 700 can be secured, for example, to a rear wall of the recess. In such embodiments, instead of a fireplace cabinet 1200, the system 100 may be configured to aesthetically appear to be a substantially flat ornamental piece mounted to the wall.

Regardless of whether the system 100 is installed on a wall or in a recess, the rapid integration of all of the components described above into a system 100 providing the appearance of fireplace is a safe, novel and cost-effeetive method of introducing heating, air conditioning, dehumidification and air filtration into a building. The “all-in-one” configuration which easily attaches to the heat pump indoor unit 200 greatly simplifies installation and thus reduces installed cost.

This case of assembly and installation is accomplished with accessories and components such as the heat pump floor stand 300, mounting brackets 400, 450 and integration frame 700, which facilitate structural support for the system, quick positioning (distance from floor, distance from wall, and leveling) of the system, and easy vibration damping. In particular, the floor stand 300 and wall mounting brackets 400, 450 provide a system to ensure the ability of a single person to quickly execute proper mounting and adjustment of the indoor unit 200 and the integration frame 700 facilitates quick alignment and installation of other components.

In addition, components such as the trim plate 1000, vertical surrounds 1100, horizontal surround 1150, fireplace cabinet 1200, flame box 800, auto louvers 900, and grill 650 form an aesthetically pleasing façade, providing the system 100 with a pleasing appearance suitable for placement in a prominent area while still shielding/protecting the indoor unit 200, providing openings for supply air and return air, and providing access for maintenance. In addition, such components, especially the fireplace cabinet 1200, horizontal surround 1150, vertical surrounds 1100, and trim plate 1000, also provide customizable or easily altered design elements of the system.

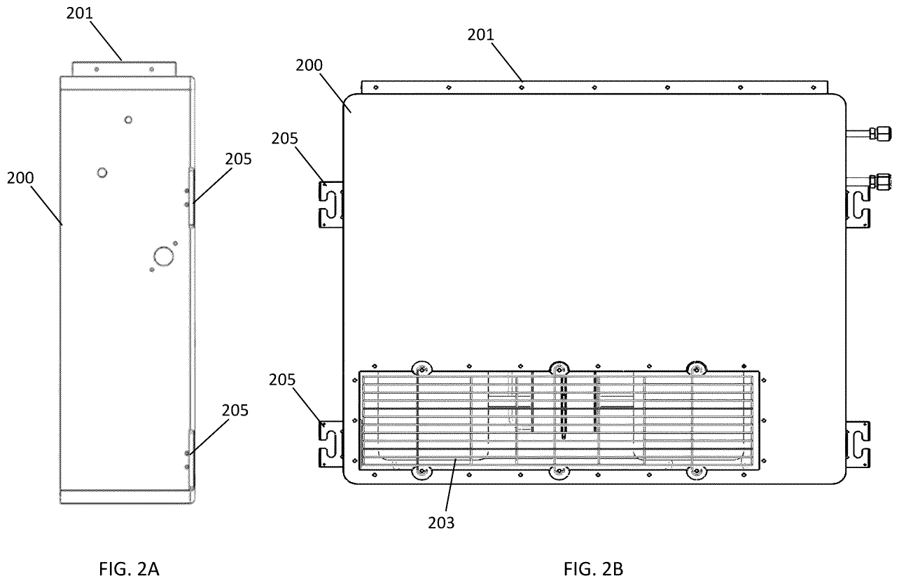

Referring now to FIGS. 2A-2B, the indoor unit 200 can be vertically oriented such that a return air inlet 203 is positioned facing forward and a supply air outlet 201 is facing upward on top of the indoor unit 200. The indoor unit 200 can also include one or more mounting tabs 205 extending from a side thereof. As shown, the mounting tabs extend from the side proximate the back of the indoor unit 200 for convenience in attaching the wall brackets 400, 450.

As shown and described herein, the indoor unit 200 is an off the shelf slim duct air source heat pump indoor unit vertically mounted and connected to a corresponding outdoor unit with refrigerant lines as well as electric power and installed in accordance with the manufacturer's directions. In general, the indoor unit 200 must be of the dimensions to fit within an enclosure providing the aesthetic of a fireplace. It is the need to fit within the rectangular geometry and dimensions typical of a fireplace that makes a vertical orientation advantageous.

However, mounting the indoor unit 200 vertically at floor level provides several advantages, including, for example:
1. Allowing refrigerant lines to exit to the exterior of building to connect to the outdoor unit at a low level (as opposed to higher on wall), which facilitates short line sets for efficient operation of the system 100 and facilitates an easy installation. This is also advantageous because long refrigerant lines add to the cost of installation and detract from system efficiency.
2. Allowing refrigerant lines to be easily run through the floor, thereby accommodating installation on an interior wall.
3. Floor level placement allows for easy installation and easy maintenance (no ladder required) with the heat pump indoor unit readily accessible for both the installation technician and the consumer.
4. Lower on the wall is an ideal location for optimal air supply and distribution. It is well understood that ceiling vents are preferred for cooling and floor vents are preferred for heating. A low wall location located in a central area of the home is the ideal arrangement for both heating and cooling functions. A traditional wall mounted indoor unit must blow the warm air toward the floor at a high velocity, often creating a draft. Due to the low wall design of the system 100 provided herein, the indoor unit 200 does not need to blow warm air from an elevated height to disperse into the room and thus the fan speed can run at low power in the heating mode.

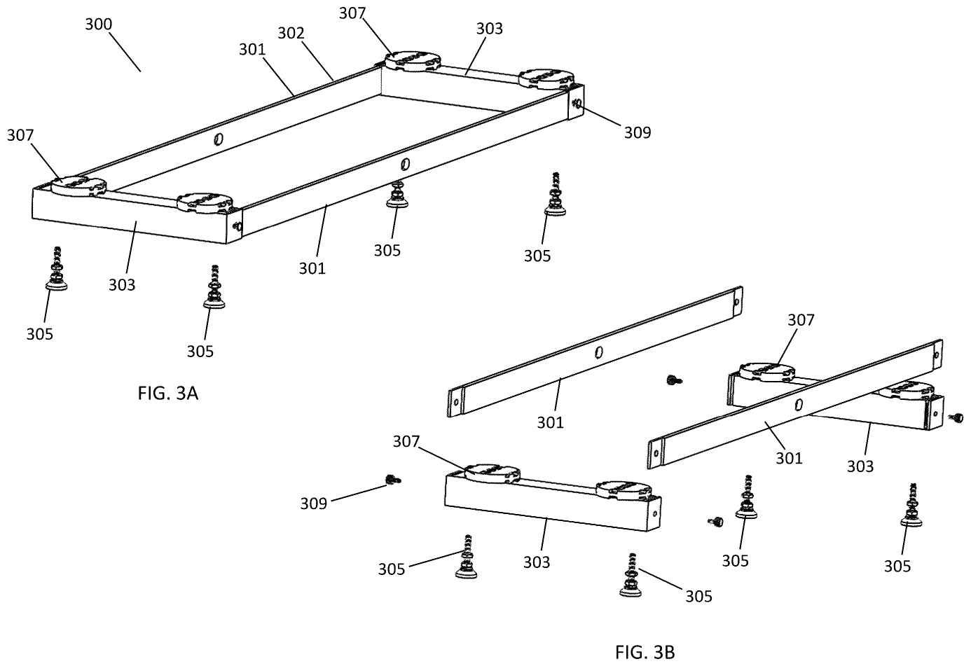

Referring now to FIGS. 3A-3B the floor stand 300 can be generally rectangular or otherwise shaped to receive the indoor unit 200 thereon. The floor stand 300 includes opposing side rails 301 attachable to opposing end rails 303 to form a rigid stand frame 302 of the floor stand 300. The side rails 301 can be attached to the end rails 303 by any suitable means including, for example, screws or bolts (as shown), mating slots, tabs, welding, combinations thereof, or any other suitable means.

An upper surface of the stand frame 302 can be provided with one or more vibration dampening pads 307 and/or can be coated over its entirety with a vibration dampening material to provide vibration dampening between the indoor unit 200 and the floor, thus reducing noise and vibration introduced to the home during operation.

The floor stand 300 also includes one or more feet 305 configured to extend downward from a lower surface of the stand frame 302. The feet 305 can be separate from (as shown) or integrated with one or more elements of the stand frame 302 such as the side rails 301 and end rails 303. In some embodiments, the feet 305 can extend a fixed length downward from the stand frame 302. However, the use of length-adjustable feet 305 as shown in FIGS. 3A-3B is preferable because adjusting the length of such feet provides a leveling function of the floor stand 300. In particular, when the floor stand 300 is placed on an uneven floor with the indoor unit 200 mounted thereon, contact between all of the feet 305 and the floor can be maintained and the indoor unit 200 can be leveled by adjusting the lengths of one or more of the adjustable feet 305, thereby preventing wobbling or other instability and ensuring proper operation of the indoor unit 200.

In this manner, the floor stand 300 is easily assembled, supports the weight of the indoor unit 200, provides necessary clearance from the floor, allows for quick leveling and provides vibration damping.

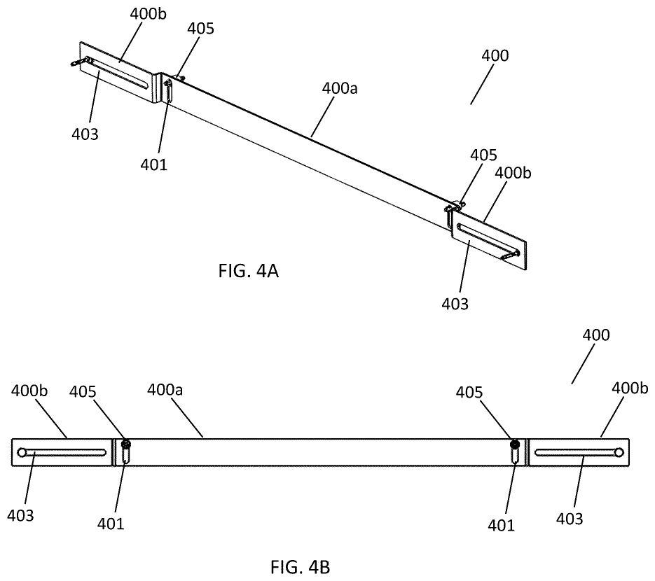

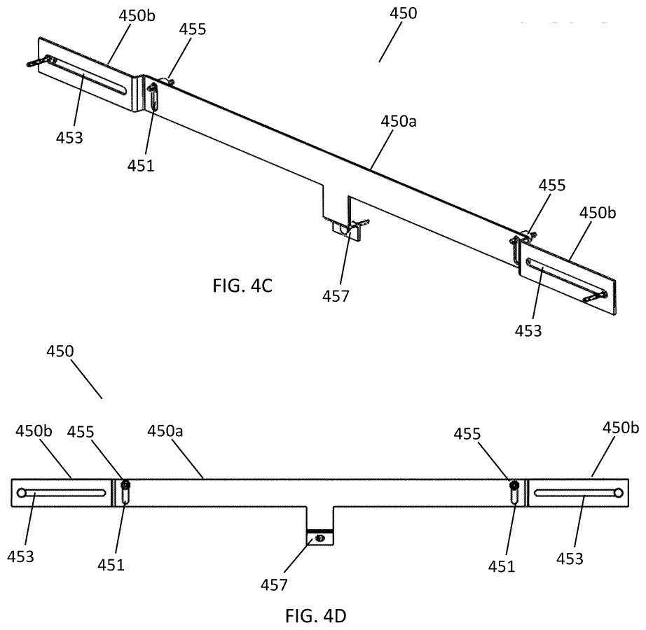

Referring now to FIGS. 4A-4B, the upper wall bracket 400 is an elongated bracket having a central segment 400a and opposing wings 400b extending therefrom. In some embodiments, the wings 400b are offset from the central segment 400a in order to provide spacing between the indoor unit 200 and the vertical wall to which it is being mounted. The central segment 400a is sized to extend at least across a width of the indoor unit 200 so that vertical attachment slots 401 can be used to attach the upper wall bracket 400 to mounting tabs 205 of the indoor unit 200. The wings 400b extend outward from the central segment 400a and include horizontal slots 403 for mounting the upper wall bracket 400 (and thus the indoor unit 200) to the wall. The horizontal slots 403 can advantageously permit locational adjustment of the attachment point as needed for alignment with structural elements of the wall such as, for example, studs. In some embodiments, the upper wall bracket 400 can also be provided with one or more vibration dampening fasteners 405 for attaching the upper wall bracket 400 to the indoor unit 200. Use of such vibration dampening fasteners 405 can advantageously reduce noise and vibration introduced to the home during operation of the indoor unit 200.

Referring now to FIGS. 4C-4D, the lower wall bracket 450 is largely similar to the upper wall bracket 400. The lower wall bracket 450 is an elongated bracket having a central segment 450a and opposing wings 405b extending therefrom. In some embodiments, the wings 450b are offset from the central segment 450a in order to provide spacing between the indoor unit 200 and the vertical wall to which it is being mounted. The central segment 450a is sized to extend at least across a width of the indoor unit 200 so that vertical attachment slots 451 can be used to attach the lower wall bracket 450 to mounting tabs 205 of the indoor unit 200. The wings 450b extend outward from the central segment 450a and include horizontal slots 453 for mounting the lower wall bracket 450 (and thus the indoor unit 200) to the wall. The horizontal slots 453 can advantageously permit locational adjustment of the attachment point as needed for alignment with structural elements of the wall such as, for example, studs. In some embodiments, the lower wall bracket 450 can also be provided with one or more vibration dampening fasteners 455 for attaching the lower wall bracket 450 to the indoor unit 200. Use of such vibration dampening fasteners 455 can advantageously reduce noise and vibration introduced to the home during operation of the indoor unit 200.

The lower wall bracket 450 also includes a floor stand attachment tab 457 for attachment between the lower wall bracket 450 and the floor stand 300. The floor stand attachment tab 457 extends downward perpendicular to the central segment 450a for alignment with the floor stand 300 when the lower wall bracket 450 is mounted to the indoor unit 200. In some embodiments, the floor stand attachment tab 457 can extend straight downward from the central segment 400a or instead can have an offset arrangement as shown for wrapping under the indoor unit 200 and approaching a side rail 301 of the floor stand 300 (e.g., where a dimensional footprint of the floor stand 300 is smaller than a dimensional footprint of the indoor unit 200) for attachment thereto.

In this manner, the upper and lower wall mounting brackets 400, 450 secure the indoor unit 200 to the wall while providing the necessary spacing clearance between the indoor unit 200 and the wall. In addition, the brackets also provide vibration damping via vibration dampening fasteners 405, 455 and the horizontal slots 403, 453 allow for easy attachment to wall studs for secure mounting. Thus, the quick assembly and design of the stand and wall mounting brackets 400, 450 facilitates easy installation by a single person to minimize installation time and cost.

### Supply Air Elbow

The conditioned air exits the supply air outlet 201 of the indoor unit 200 in an upward orientation. However, the air must be reoriented by about 90 degrees for the flow to be directed out a front of the system 100 and into the conditioned room. It is also desirable for such reorientation of the air to be achieved in a manner that is efficient (low energy loss) and low noise. In addition, it is desirable for such a solution to be simple to manufacture and install.

The need to turn air 90 degrees in a rectangular duct is a common requirement of HVAC systems, among others. The accepted solutions range in efficiency, cost, and complexity. Some examples include A: a radius elbow with radius throat, B: a radius elbow with square throat, C: a square elbow with running vanes and rails, and D: a square elbow with square throat. Each of these four elbow types will re-direct the air 90 degrees. However, it is well known that D, a square elbow with square throat, will lead to turbulent flow, which can be manifested as resistance to air flow, noise, and vibration and thus A, B and C which incorporate rounded elbows or turning vanes are preferred. That preference has developed because rounded elbows (A and B) and turning vane elbows (C) assist in redirecting the air in a smooth (uniform) manner, to reduce turbulent flow and energy loss. These methods however add considerable cost and complexity to the system in terms of both manufacturing and installation.

In order to maintain the performance of rounded or vaned elbows while maintaining a simple, low-cost form factor and easy installation, provided herein are foldable supply air quick assemble elbows 500 (“supply air elbow 500”) with turning baffle 525.

As described in more detail below, the supply air elbow 500 with turning baffle 525 quickly creates an effective redirection of the supply air in a confined space while being very easy to assemble and install. This is achieved by the use of a precut foldable duct board for simplified assembly and installation of the system in under thirty minutes. The turning baffle 525 facilities integration within the supply elbow in a quick and accurate fashion.

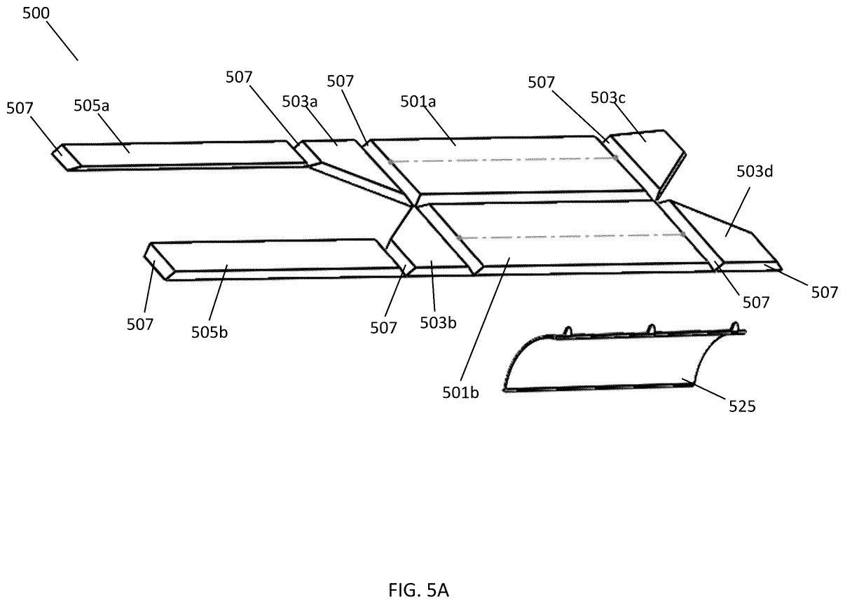

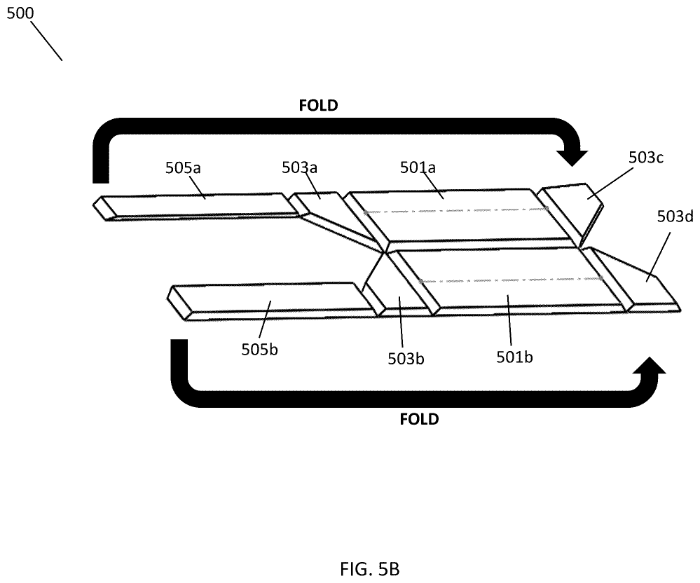

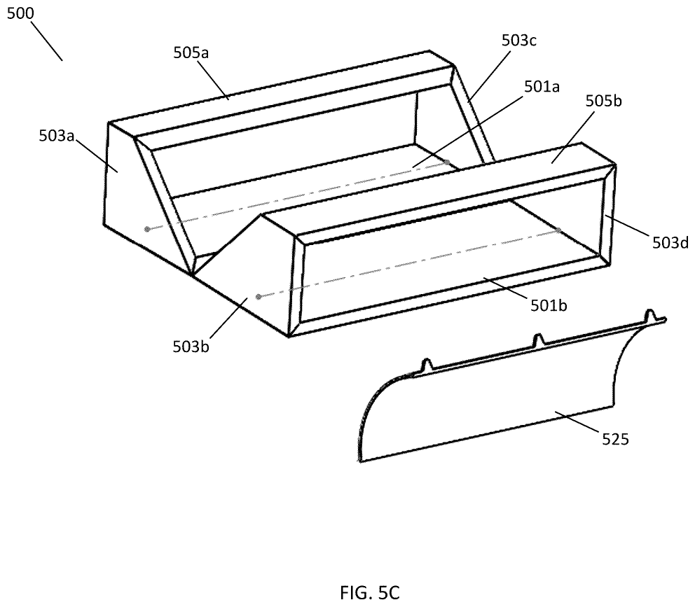

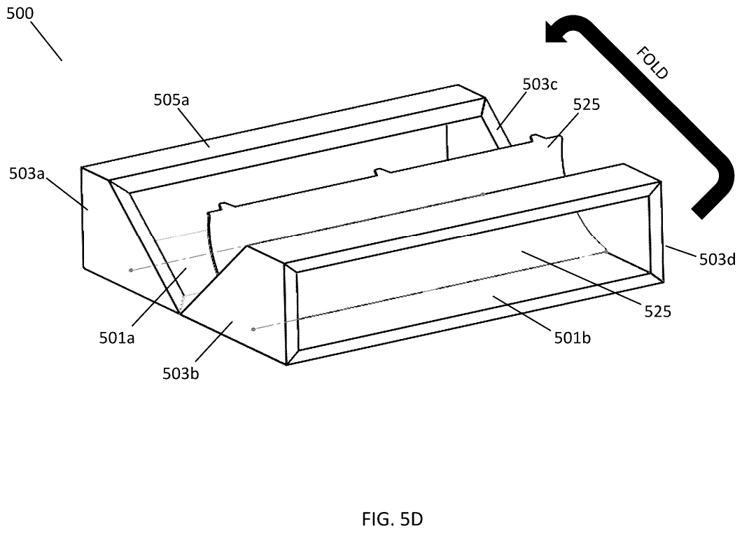

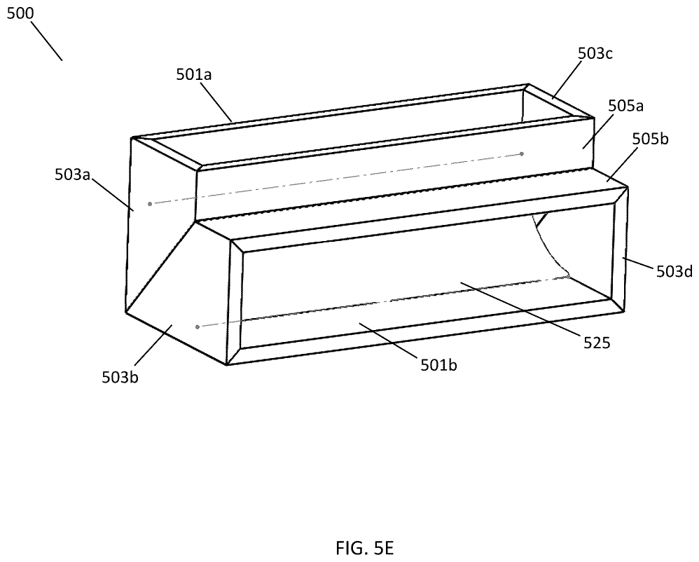

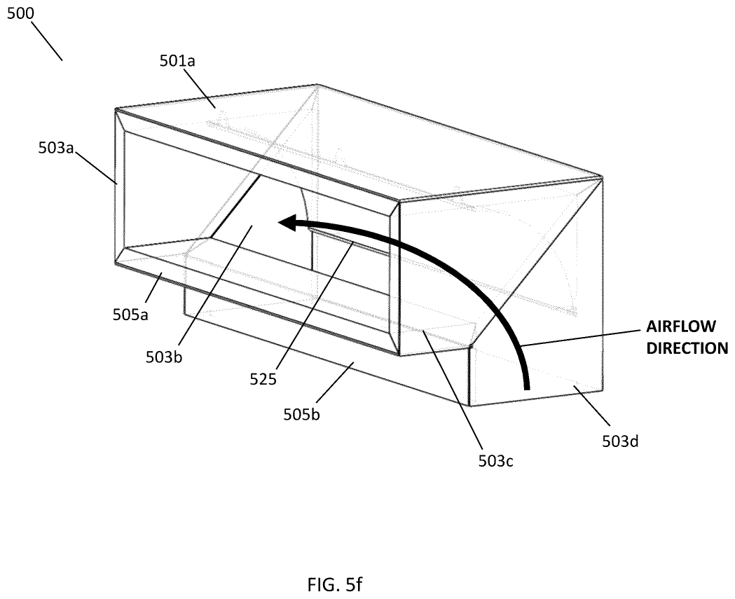

Referring now to FIGS. 5A-5f, the supply air elbow 500 can generally be any duct configured to be placed in fluid communication with the supply air outlet of the indoor unit 200 for turning a supply airflow exiting the supply air outlet 201 from a vertical direction toward a more horizontal direction for exiting a front of the system 100. As noted above and shown in FIGS. 5A-5f, the supply air elbow 500 provided herein is a novel foldable quick assemble elbow 500 with a turning baffle 525. The supply air elbow 500 described below advantageously provides a means of turning air 90 degrees which is quick to assemble and install, low cost to manufacture and transport, efficient or low energy loss, quiet, and insulative.

The supply air elbow 500 is formed from one or more precut duct boards constructed from insulative fiber board (as shown), sheet metal, or both. The most common type of rigid air duct material is sheet metal, typically galvanized steel or aluminum, because sheet metal elbow ducts are relatively low cost and non-porous meaning they cannot be easily infeeted with mold or other fungi. However, sheet metal ducts have low thermal resistance and need to be insulated. Additionally, sheet metal ducts often pop or create noise during expansion and contraction, which is highly undesirable for in-home applications. Another common ducting material is fiberboard. This material typically comes with a foil face on the outside and an anti-microbial coating on the inside. The fiberboard material is excellent in terms of acoustics and thermal properties and often less expensive than sheet metal ducting when fabrication of the elbow is considered. It is self-insulated, meaning it acts as a type of insulation, and is resistant to mold and fungi.

Referring now to FIG. 5A, the precut board includes two substantially rectangular outer elbow wall elements 501a, 501b that form the rear and upward facing walls (outside the bend) of the elbow 500 after assembly. The outer elbow elements 501a, 501b are foldably attached along a shared side as shown. The precut board also includes four side elbow wall elements 503a-d that form the sides of the elbow 500 after assembly. Each side elbow wall element 503a-d has a long end foldably attached to and coextensive with an end of one of the first and second outer elbow wall elements 501a-b, a short end opposite the long end, an angled side extending from a corner of the attached outer elbow wall element 501a-b on the shared side toward the short side of the side elbow wall element 503a-d, and a straight side extending from a non-shared corner along the non-shared side of the attached outer elbow wall element 501a-b.

The precut board also includes two substantially rectangular inner elbow wall elements 505a, 505b that form the lower and forward-facing walls (inside the bend) of the elbow 500 when assembled. The first inner elbow wall element 505a includes one end foldably attached to the short side of a first one of the side elbow wall elements 503a, which is, in turn, attached to the first outer elbow wall element 501a. Similarly, the second inner elbow wall element 505b includes one end foldably attached to the short side of a second one of the side elbow wall elements 503b, which is, in turn, attached to the second outer elbow wall element 501b.

In some embodiments, each of the outer elbow elements 501a-b, side elbow wall elements 503a-d, and the inner elbow wall elements 505a-b can include a chamfered edge extending around at least a portion of the perimeter thereof. In particular, the shared side of the outer elbow elements 501a-b, each of the long ends and short ends of the side elbow wall elements 503a-d, each of the attached and free ends of the inner elbow wall elements 505a-b includes an angled chamfer to restrict geometry of the folded configuration to a desired shape of the supply air elbow 500 (e.g., chamfered at 45 degrees to form a 90 degree angle when assembled). For all foldably attached sides, the angled chamfer can, for example, terminate at the foil layer or aluminum tape so as to permit folding between the attached elements.

As best shown in FIGS. 5B-5F, assembling the supply air elbow 500 is a matter of simply folding and taping in several steps. Referring to FIGS. 5B-5C, moving the free end of the first inner elbow wall element 505a toward the short end of the third side elbow wall element 503c also causes folding between the first inner elbow wall element 505a and the first side elbow wall element 503a, between the first side elbow wall element 503a and the first outer elbow wall element 501a, and between the first outer elbow wall element 501a and the third side elbow wall element 503c, all of which brings the free end of the first inner elbow wall element 505a into contact with the short side of the third side elbow wall element 503c for attachment thereto to form a first rectangular flowpath. Similarly, moving the free end of the second inner elbow wall element 505b toward the short end of the fourth side elbow wall element 503d also causes folding between the second inner elbow wall element 505b and the second side elbow wall element 503b, between the second side elbow wall element 503b and the second outer elbow wall element 501b, and between the second outer elbow wall element 501b and the fourth side elbow wall element 503d, all of which brings the free end of the second inner elbow wall element 505b into contact with the short side of the fourth side elbow wall element 503d for attachment thereto to form a second rectangular flowpath.

As shown in FIG. 5D, the turning baffle 525 can then be installed, at least at one end, within the supply air elbow 500. The baffle 525 is preferable constructed as a curved sheet. Although the baffle can be constructed of any suitable material as discussed above with reference to the elbow 500, such baffles 525, being positioned inside the elbow, do not typically need to be insulated and thus a simple sheet metal construction is preferable for cost, formability, and thinness. The baffle 525 can be installed for assembled contact and/or attachment with both of the outer elbow wall elements 501a-b. In this regard, the baffle 525 may be, or include one or more tabs which are, insertable into, for example, a slot of each outer elbow wall elements 501a-b as shown. Alternatively, or in addition, the baffle 525 can be attached to the elbow 500 by one or more fasteners or adhesives in order to secure it within the elbow 500. In addition, the baffle 525 is curved and positioned to turn supply airflow exiting the supply air outlet 201 of the indoor unit 200 toward the front of the system 100 for egress into the conditioned room. In general, the curvature of the radius elbow baffle can preferably be greater than or equal to the width of the duct to promote uniform airflow and low pressure drop.

Referring to FIGS. 5D-5E, the first and second flowpaths are foldable along the shared side of the first and second rectangular outer elbow wall elements 501a-b to bring the angled sides of the first and second side elbow wall elements 503a-b into contact, the angled sides of the third and fourth side elbow wall elements 503c-d into contact, and inner sides of the first and second inner elbow wall elements 505a-b into contact for attachment therebetween to form a folded, assembled configuration of the supply air elbow 500.

In this manner, the supply air elbow 500 with baffle 525 provides many improvements and advantages over traditional turning elbows including, for example:
1. Acoustic Performance: Fibrous duct board does not create duct noise by popping or booming due to expansion and contraction as is the case with sheet metal ducts. Sheet metal can reverberate or amplify the noise and transmits vibration when common design techniques are used. Fibrous duct board also reduces noise associated with the blower, as well as any air turbulence within the duct.
2. Thermal Resistance: Insulation must be added to traditional metal ducting whereas fibrous board is made with high thermal resistance material.
3. Ease of manufacturing and shipping. The metal duct elbow must be manufactured at a sheet metal facility and results in a large volume component. The fibrous board is very easily cut and remains a lightweight flat component to facilitate storage and shipping.
4. Ease of assembly. The pre-cut rigid duct board folds into shape in as little time as one minute and can be easily connected to the heat exchanger without the danger of sharp edges as is the case with standard metal ducts.
5. Cost effectiveness: Without fabrication and insulation costs associated with conventional metal ducts, the rigid duct board in the most cost-effective solution.

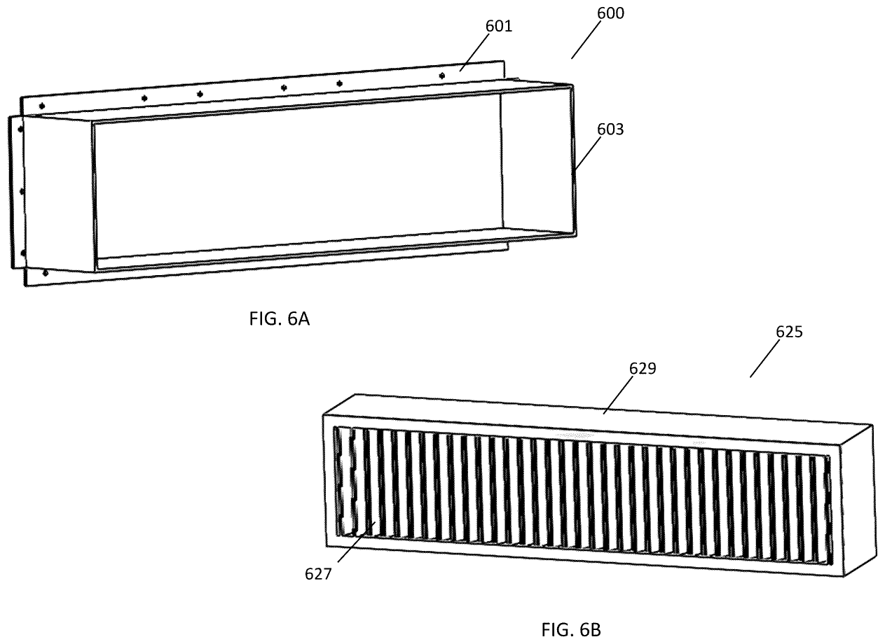

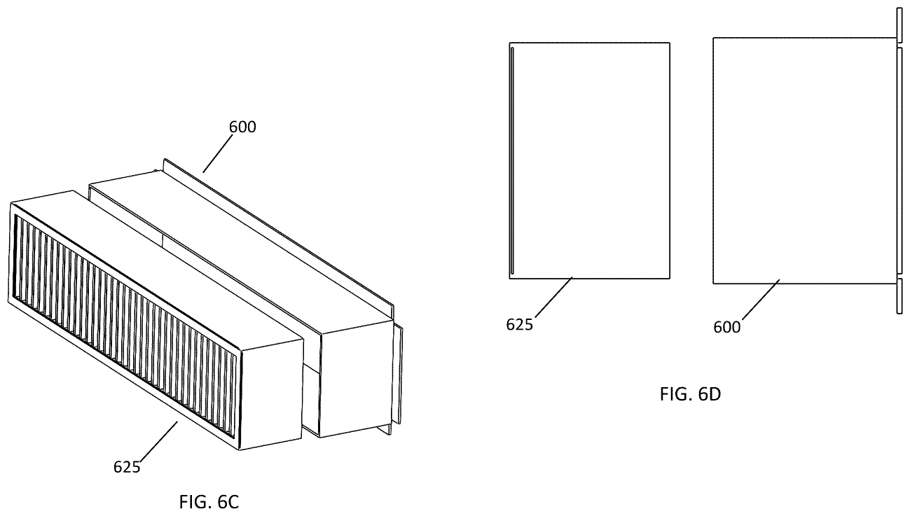

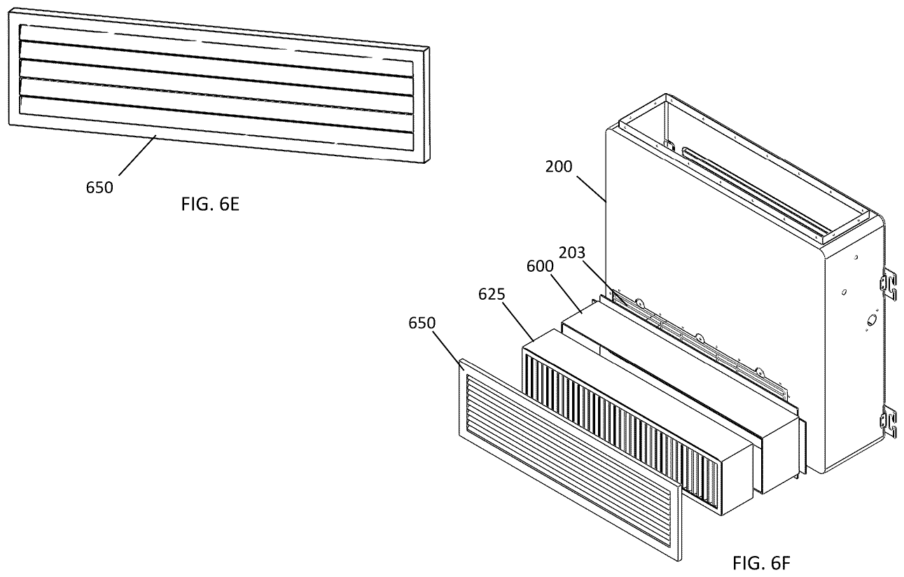

Referring now to FIGS. 6A-6F, a return air duct 600 is provided for attachment by a flange 601 thereof to the indoor unit 200 in fluid communication with the return air inlet 203 thereof. The return air duct 600 includes a duct 603 extending outward from the flange, the duct 603 sized and shaped to receive a filter 625. The filter 625 includes a filter frame 629 having a filter media 627 installed therein to provide filtration for the return air flowing into the inlet. In some embodiments, the filter media 627 can preferably be pleated as shown.

In some embodiments, as shown and described herein, the filter 625 can preferably be a low resistance deep pleated filter. The filter 625 can preferably fill the entire return air duct 600 as shown. Deep pleated filters (e.g., 2 in deep or more, preferably at least 4 in deep) is provided more surface area than shallower filters and therefore allows more surface area for air to pass over, resulting in a lower pressure drop across the filter 625. Generally, a high-pressure drop can result in restricting flow through the indoor unit 200, thereby degrading performance and efficiency of the system 100. For optimum performance, the filter 625 must stay within the static pressure capacity of the heat pump indoor unit 200. The filter 600 can achieve a lower static pressure drop with the inclusion of more surface area and/or more pleats. As shown, the filter provided is a 6⅛″×22⅛″×4″ air filter with 20 pleats, which achieves a low pressure drop of about 0.2 in WC and offers MERV 13 filtration. However, it will be apparent in view of this disclosure that any filter of suitable size, depth, and filtration performance can be used in accordance with various embodiments so long as the pressure drop across the filter and other associated components is less than the static pressure capacity of the indoor unit 200.

An additional advantage of using such thick/deep pleated filters is that, due to their increased surface area, such filters have additional benefits such as higher dust-holding ability, meaning the amount of dust that can be captured and retained by the filter without blocking airflow. Accordingly, such filters do not have to be changed as often as other filters.

With respect to assembly, maintenance, and aesthetics, the filter 625 readily slides into the air return duct 600 and can be shielded by a removable, preferably magnetic, grill 650, which can also be ornamentally designed.

Such filtration is beneficial because the indoor heat pump unit recirculates air. That is, return air is drawn into the unit and then it passes over a coil where it is heated, cooled, or dehumidified before it is distributed back to the room. Most heat pump indoor units 200 include an air filter to protect the system. However, such filters fall short of filtering air to the extent recommended by the American Society of Heating Refrigeration and Air Conditioning Engineers (ASHRAE).

For example, some indoor units 200 include a washable filter to protect the unit but also recommend a separate “field supplied filter” to address indoor air quality (IAQ). ASHRAE recommends an air filter with a Minimum Efficiency Reporting Value (MERV) rating of at least 13. The problem with achieving this recommendation is that higher filtration (higher MERV rating) leads to increased pressure drop which can lead to reduced air flow through an HVAC system. Thus, consumers are frequently left with a recommendation which is simply not possible to achieve. This problem of using a “field supplied” filter is evidenced by the fact that no filter with a sufficiently low pressure drop readily exists which can fit in the return air inlet 203 of the indoor unit 200. However, the filter 625 provided herein, in combination with the return air duct 600 provided herein, demonstrates the capability to implement such recommendations.

Several improvements and advantages are realized by the return air duct 600, filter 625, and magnetic grill 650 provided herein, including, for example:
1. As previously noted, many HVAC systems are positioned in attics, basement, closets, or utility room. Filtering air away from the source of contamination is problematic for contaminants are allowed to disperse into the surrounding environment before they are trapped. Filters work best when they are positioned as close as possible to the source of contamination or where air intake occurs. Accordingly, the placement of the air filter within the ornamental enclosure in a prominent or central location which is facilitated by the invention represents a significant opportunity for improved IAQ.
2. Facilitation of filtering air in central area of dwelling where filtering will likely be close to the source of contamination.
3. Facilitation of filtering of air close to the floor where contaminants are likely to have the greatest concentration.
4. Simplifies and makes changing of the filter 625 easy and straightforward by locating the filter in an easily accessed enclosure within the living area.
5. Facilitates advanced filtration with low resistance to air flow (low pressure drop).

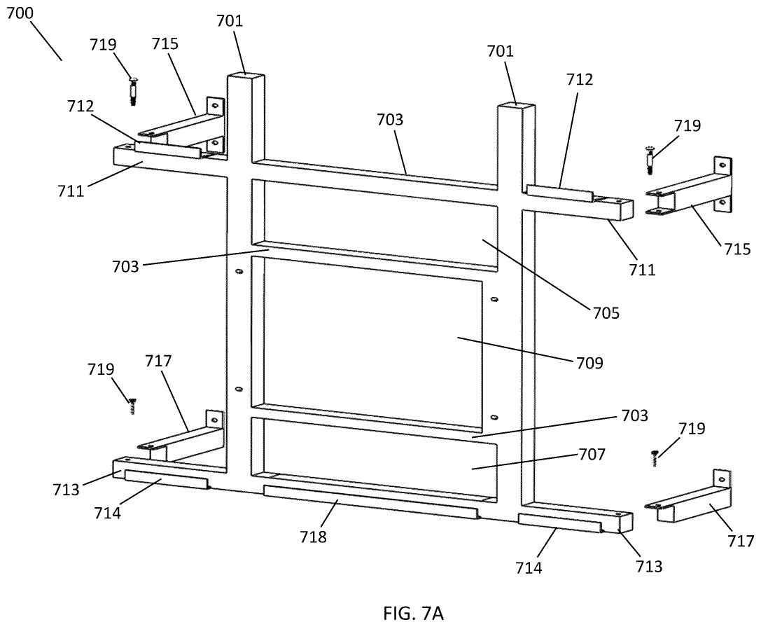

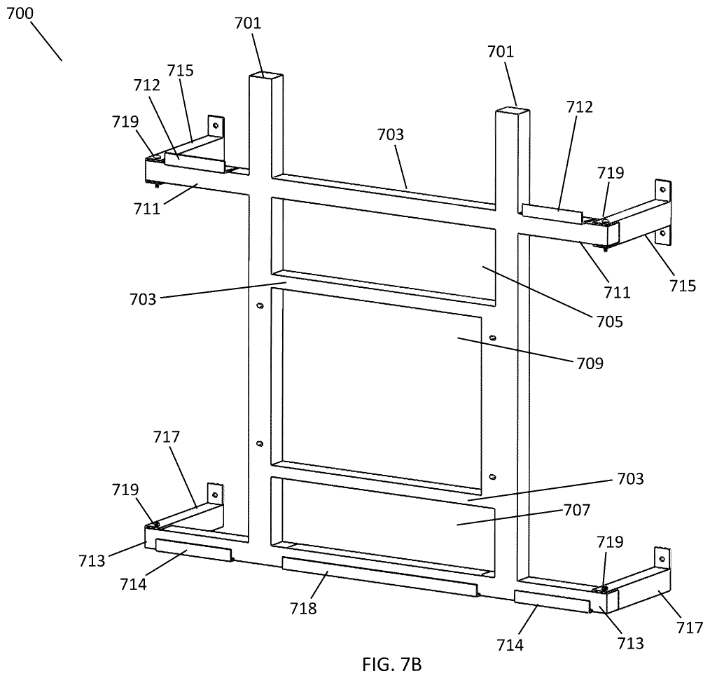

Referring now to FIGS. 7A-7B the integration frame 700 includes first and second vertical posts 701 and a plurality of horizontal supports 703 extending between the vertical posts 701. Together, the vertical posts 701 and the horizontal supports 703 define a supply air frame aperture 705 for alignment with an outlet of the supply air elbow 500 to permit supply airflow therethrough, along with receiving and supporting the auto louvers 900. The vertical posts 701 and the horizontal supports 703 also define a return air frame aperture 707 for alignment with an inlet of the return air duct 600 and filter 625 and to permit return airflow therethrough. The vertical posts 701 and the horizontal supports 703 also define a flame box frame aperture 709 for receiving and supporting the flame box 800.

The integration frame 700 also includes horizontally opposed upper arms 711 and lower arms 713 extending outward in parallel from each of the vertical posts 701. The integration frame 700 is securable to the wall via upper wall mounts 715 and lower wall mounts 717. The upper and lower wall mounts 715, 717 can be generally oriented perpendicular to the upper and lower arms 711, 713 and, in some embodiments, can advantageously be hingedly attached (e.g., by pins 719) to upper and lower arms 711, 713 respectively so as to permit horizontal adjustment of the position the integrated frame 700 for alignment with the outlet of the supply air elbow 500 and the inlet of the return air duct 600.

The integration frame 700 can also include one or more quick attachment features for engagement, alignment, and removable attachment with one or more of the trim plate 1000, vertical surrounds 1100, the horizontal surround 1150, the grill 650, or combinations thereof. In some embodiments, as shown, such features can include one or more tabs (e.g., horizontal surround tabs 712, vertical surround tabs 714, and trim plate tabs 718). In addition, a forward-facing surface of the integration frame 700 can be provided with features such as, for example, magnets, hook and loop fasteners, detents, clips, or any other suitable removable quick attachment means.

Although described and shown herein as including one or more trim plate tabs 718, vertical surround tabs 714, and/or horizontal surround tabs 712, it will be apparent in view of this disclosure that, in some embodiments, the integration frame 700 may not include any tabs and instead may rely exclusively on quick attachment features such as those discussed herein above.

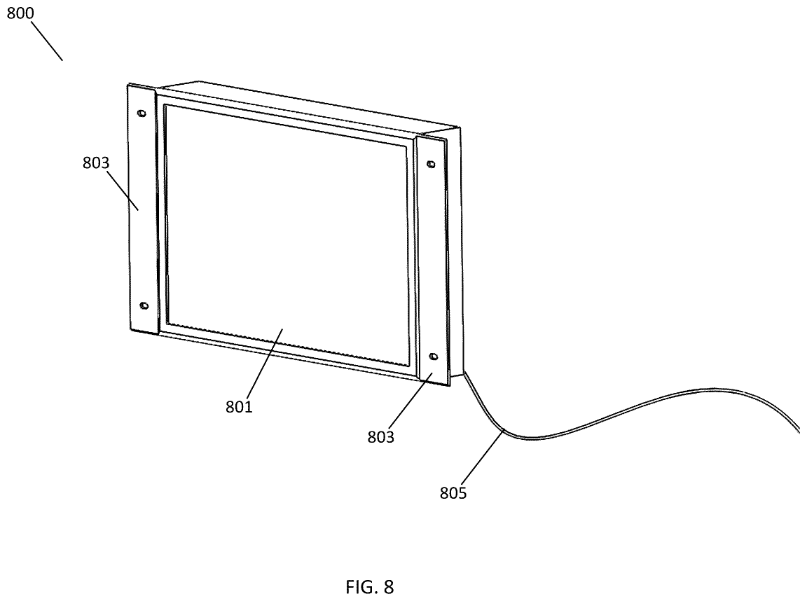

Referring now to FIG. 8, the flame box 800 includes a flame simulation display 801, an electrical cord 805 for receiving electrical power, and mounting flanges 803 for assembly of the flame box 800 to the integration frame 700 while positioned within the flame box frame aperture 709. The simulation display can be any display capable of providing the appearance of a flame such as, for example, an electronic display, an LED display, an LCD display, an OLED display, or any other suitable display. In summary, the flame box 800 specifically provides the appearance of a fire. However, it will be apparent in view of this disclosure that the flame box 800 is ornamental and does not affect operation of the heat pump system.

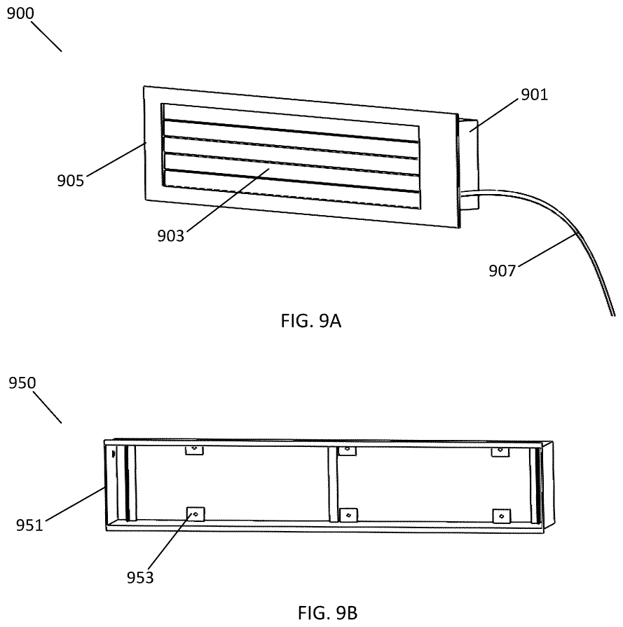

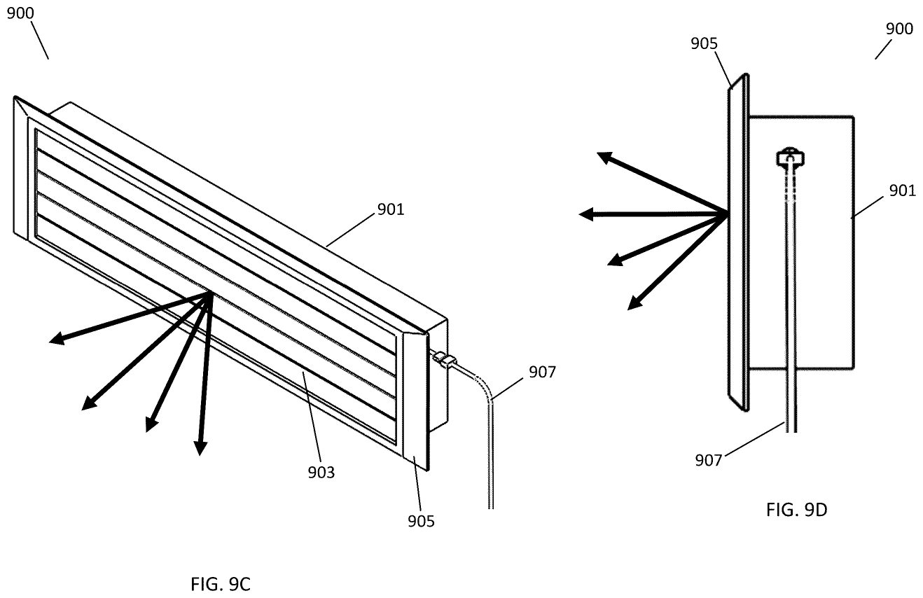

Referring now to FIGS. 9A-9D, a louver bracket 950 is provided for insertion and, in some embodiments, into the outlet of the supply air elbow 500. The bracket includes a bracket frame 951 having a plurality of mounting tabs 953 extending inward therefrom for attachment of the auto louvers 900 thereto. In this manner, the louver bracket 950 provides support and retention of the auto louvers 900 in the supply air elbow 500.

The auto louvers 900 can be any auto louver capable of directing airflow in a vertical and/or horizontal direction and suitably sized for insertion and retention in the supply air elbow 500. In this manner the auto louvers 900 provide a method of controlling the supply airflow entering the conditioned space. The auto louvers 900 can include a louver frame 901 for attachment to the louver bracket 950, a plurality of adjustable vanes 903, a flange 905 surrounding the louver frame 901 to maintain a position thereof in the outlet of the supply air elbow 500. The auto louvers 900 also include an electrical cable 907 connectable to the indoor unit 200 for receiving electrical power and/or operational control information with respect to adjustment of the vanes to redirect the supply airflow.

For example, by controlling the fan speed of the indoor unit, the operator can control the volumetric flowrate and the air velocity of the conditioned air. The louvers 900, in turn are configured to orient the air flow exiting the system 100 in both vertical and horizontal planes. The louvers 900 also add aesthetic appeal to the system by providing the appearance of a fireplace air exhaust system. The louvers can also be color matched to the fireplace flame box 800 and/or the trim plate 1000 to provide further aesthetic appeal. Additionally, when the system is not operating, the louvers 900 can be placed in a closed position to provide a sleek appearance.

Functionally, the louvers 900 can direct the air to facilitate both human comfort and/or maximum dispersion of conditioned air. Most consumers are most comfortable, for example, when the system 100 is directing warm air towards the floor and directing cool air up and directly at occupants. The louvers 900 can also be synchronized with the indoor unit 200 and a remote control thereof to provide direct the air flow in various directions or in a swing mode. In that regard, most louvers contain both horizontal and vertical adjustments.

Advantageously, the traditional placement of a fireplace in a central location makes the system 100 well suited for optimal air dispersion. The adjustable louvers 900 provide control to optimize air dispersion.

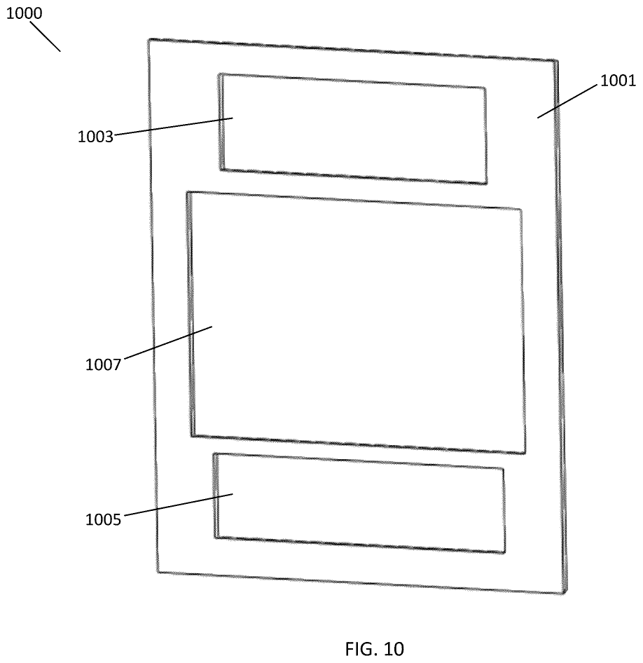

Referring now to FIG. 10 the trim plate 1000 includes a plate 1001 having a supply air trim aperture 1003 defined therein for alignment with an outlet of the supply air elbow 500 to permit supply airflow therethrough, along with receiving and supporting the auto louvers 900. The plate 1001 also includes a return air trim aperture 1005 defined therein for alignment with an inlet of the return air duct 600 and filter 625 and to permit return airflow therethrough. In addition, in some embodiments the return air trim aperture 1005 can be sized such that the magnetic grill 650 can cover the return air trim aperture 1005 and be attachable on portions of the plate 1001 surrounding the return air trim aperture 1005. The plate 1001 also includes a flame box frame aperture 1007 defined therein for alignment with the flame box 800 and sized to permit viewing of the flame display 801 of the flame box 800 while overlapping and hiding the mounting flanges 803 of the flame box 800.

A forward-facing surface of the trim plate 1000 can be provided with an ornamental design for improving an aesthetic appeal of the system 100. A rear facing side of the trim plate 1000 and/or one or more side, upper, or bottom edges thereof can include one or more quick attachment features for engagement, alignment, and removable attachment with the integration frame 700. In some embodiments, such features can include one or more tabs or tab receiving features (e.g., for receiving trim plate tabs 718 of the integration frame 700). In addition, the rear surface of the trim plate 1000 can be provided with features such as, for example, magnets, hook and loop fasteners, detents, clips, or any other suitable removable quick attachment means.

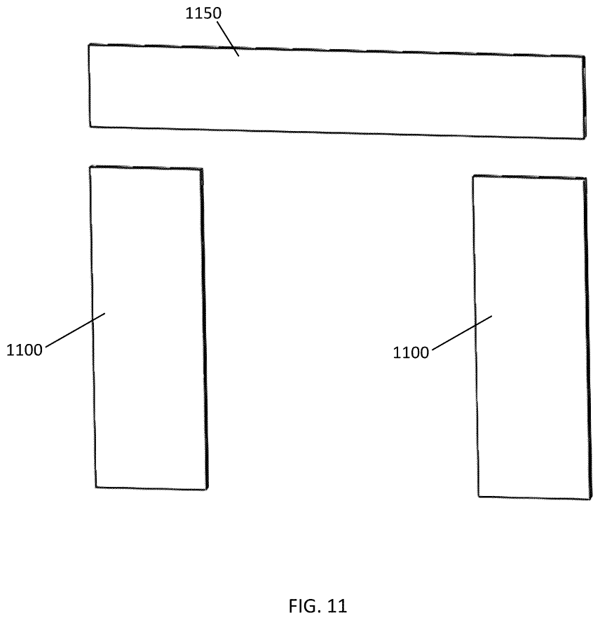

Referring now to FIG. 11, the vertical and horizontal surrounds 1100, 1150 can each include a forward-facing surface provided with an ornamental design for improving an aesthetic appeal of the system 100. A rear facing side of each of the vertical and horizontal surrounds 1100, 1150 and/or one or more side, upper, or bottom edges thereof can include one or more quick attachment features for engagement, alignment, and removable attachment with the integration frame 700. In some embodiments, such features can include one or more tabs or tab receiving features (e.g., for receiving vertical surround tabs 714 and/or horizontal surround tabs 712 of the integration frame 700). In addition, the rear surface of the vertical and horizontal surrounds 1100, 1150 can be provided with features such as, for example, magnets, hook and loop fasteners, detents, clips, or any other suitable removable quick attachment means.

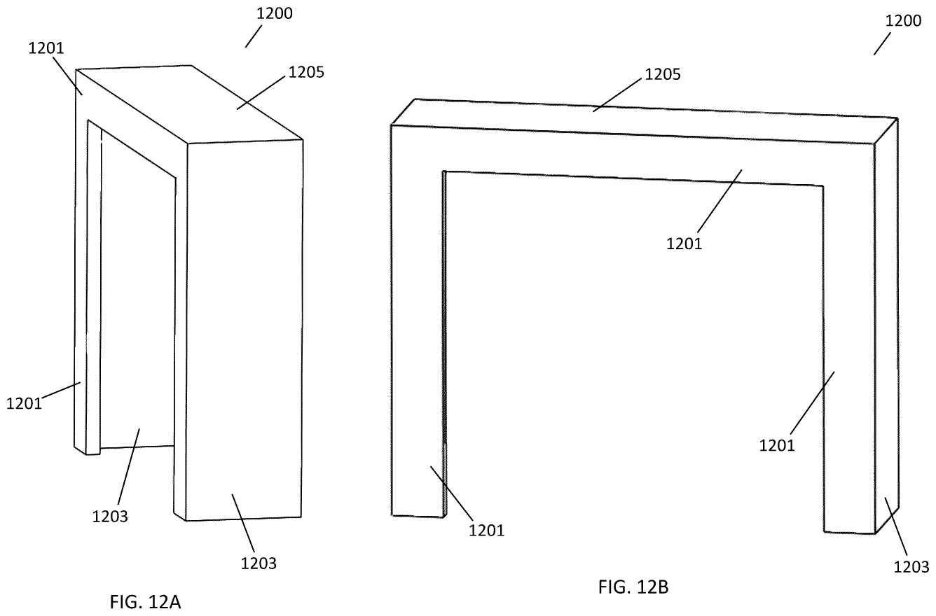

Referring now to FIGS. 12A-12B, the system 100 can be ornamentally retained within the fireplace cabinet 1200 to provide a cohesive, aesthetically pleasing appearance. The fireplace cabinet 1200 includes vertical sides 1203, an upper surface 1205, a fully open back, and a partially open front wherein a front surface 1201 extends inward from the vertical sides 1203 and upper surface 1205 to provide rigidity to the cabinet 1200 and to partially overlap the vertical surrounds 1100 and the horizontal surround 1150. Thus, when the cabinet 1200 is installed over the rest of the system 100, and the vertical sides 1203, the upper surface 1205, and the front surface 1201 are appropriately dimensioned, only the aesthetically pleasing elements such as the vertical surrounds 1100, the horizontal surrounds 1150, the trim plate 1000, the flame box 800, the grill 650, and the auto louvers 900 remain visible. In some embodiments, the fireplace cabinet 1200 can preferably be mounted to the wall for safety and stability. The fireplace cabinet 1200 can be constructed of any suitable material including, for example, fiberboard, wood, metal, glass, ceramic, sheetrock, or any other suitable, preferably rigid material.

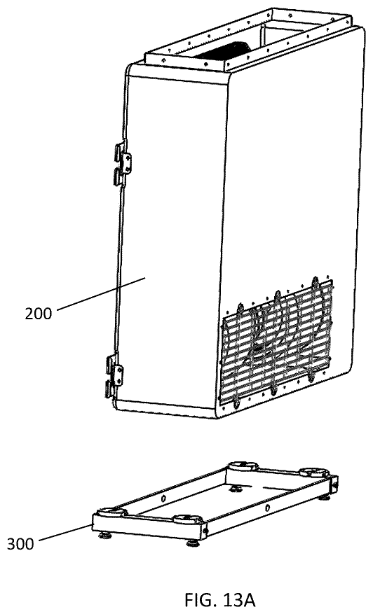

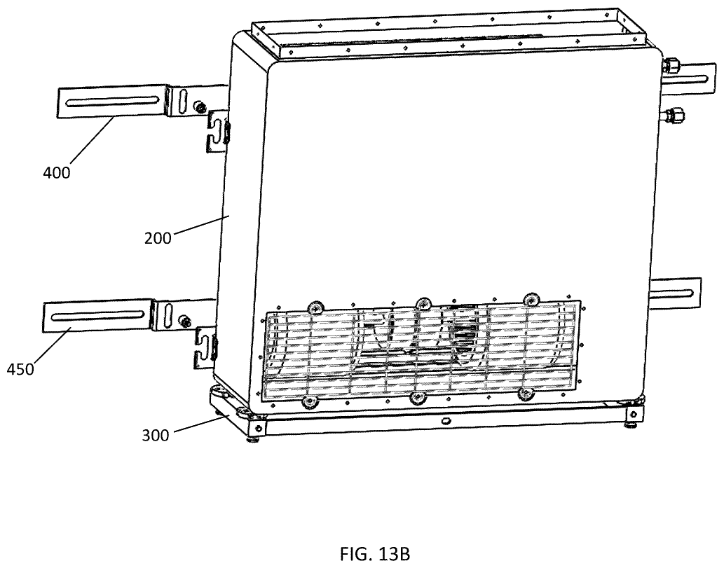

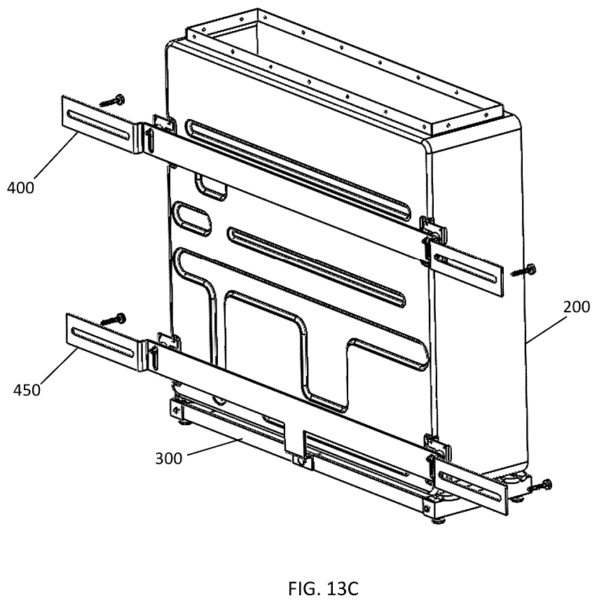

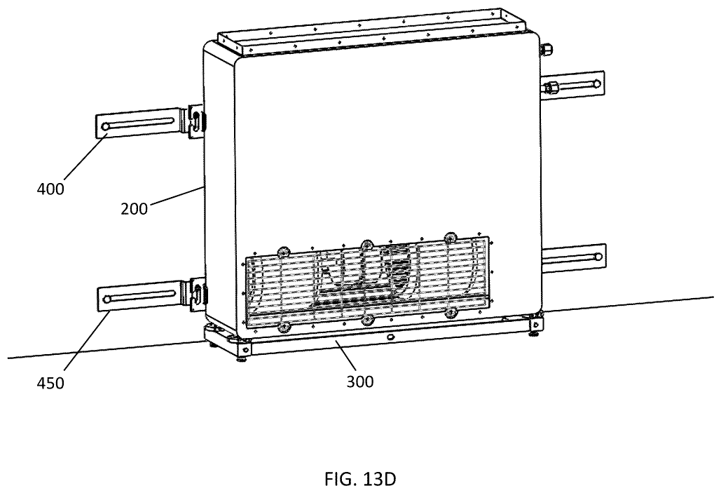

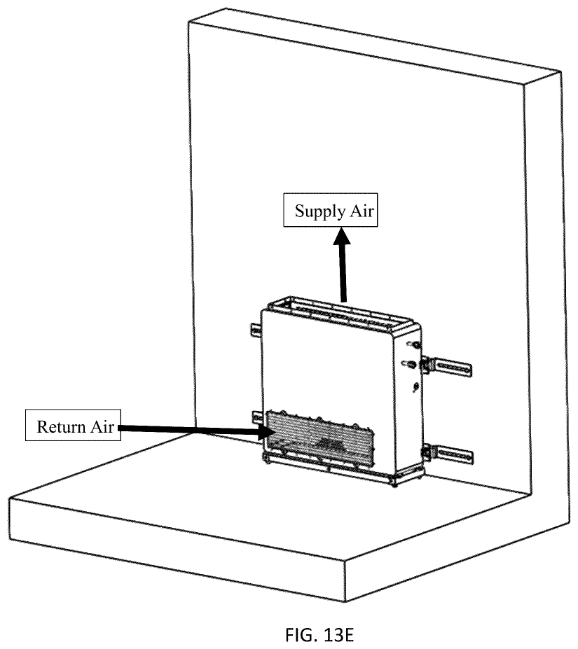

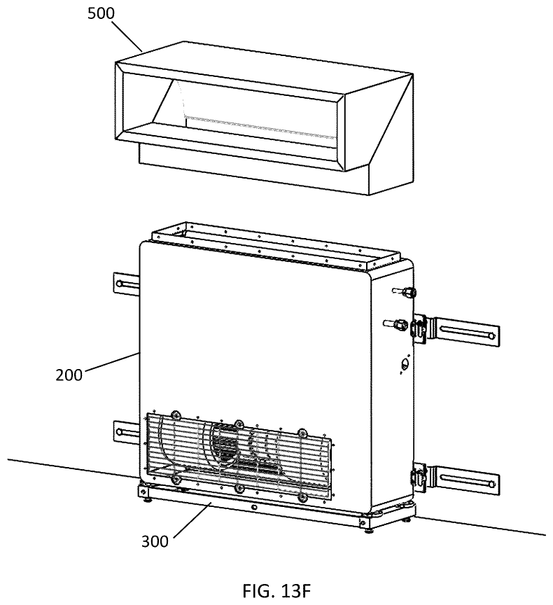

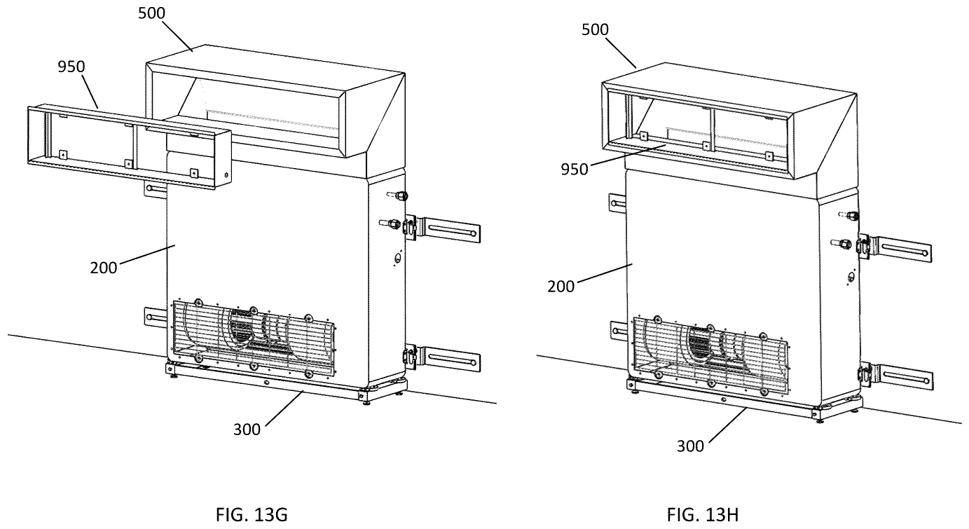

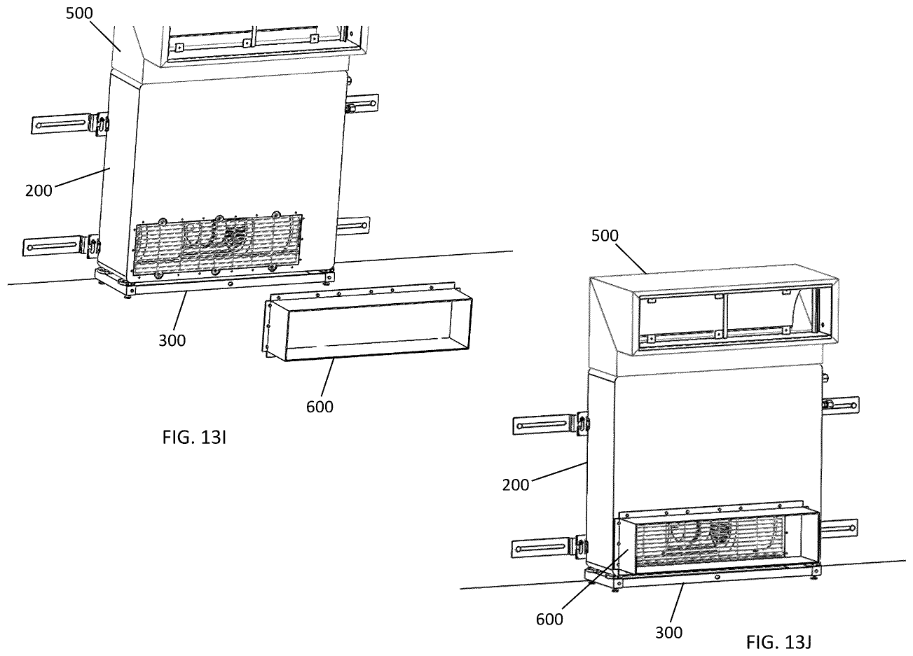

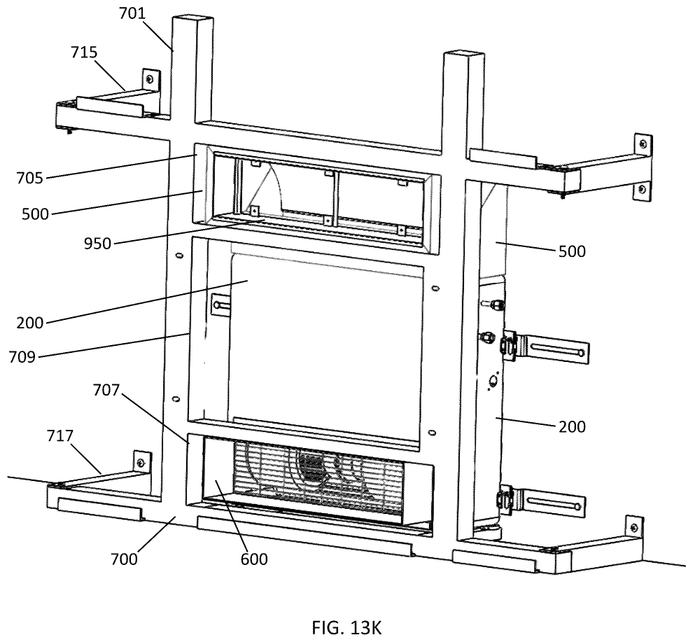

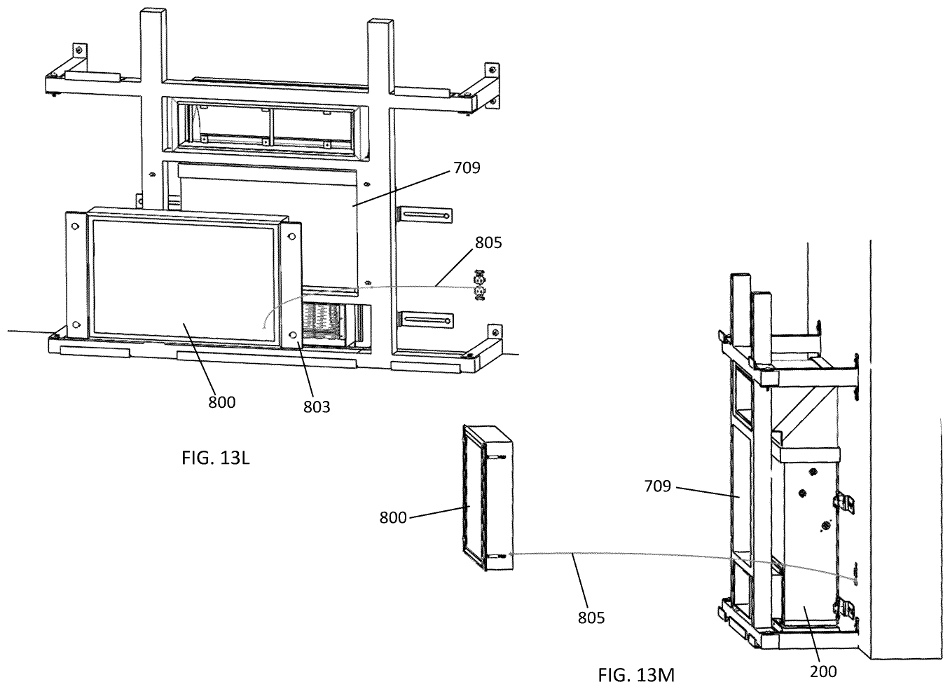

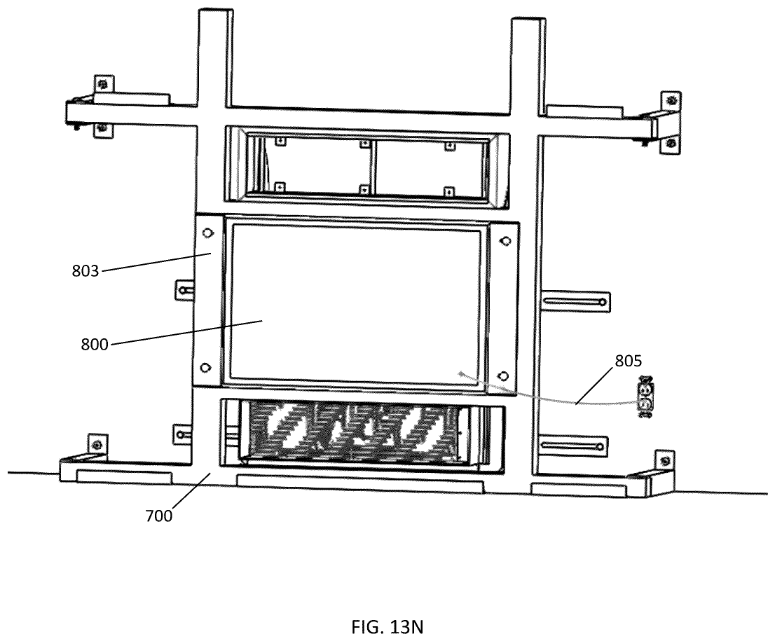

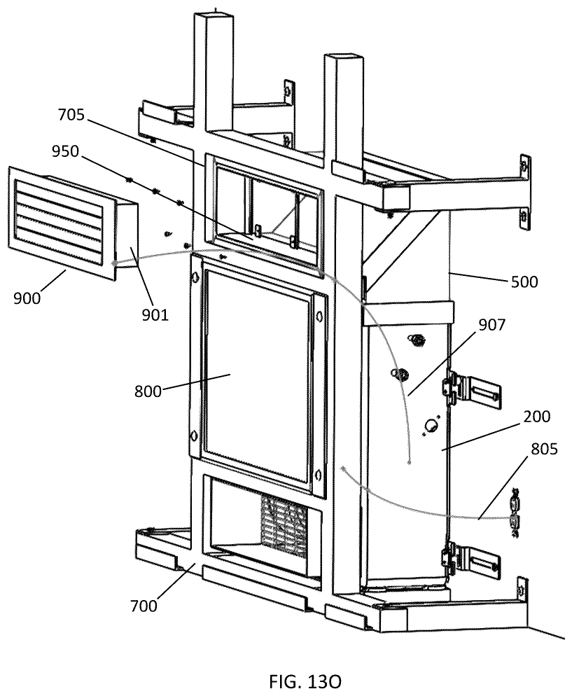

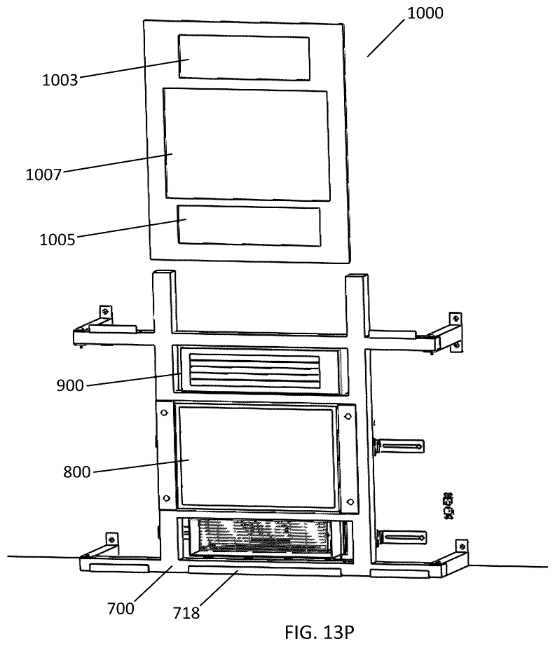

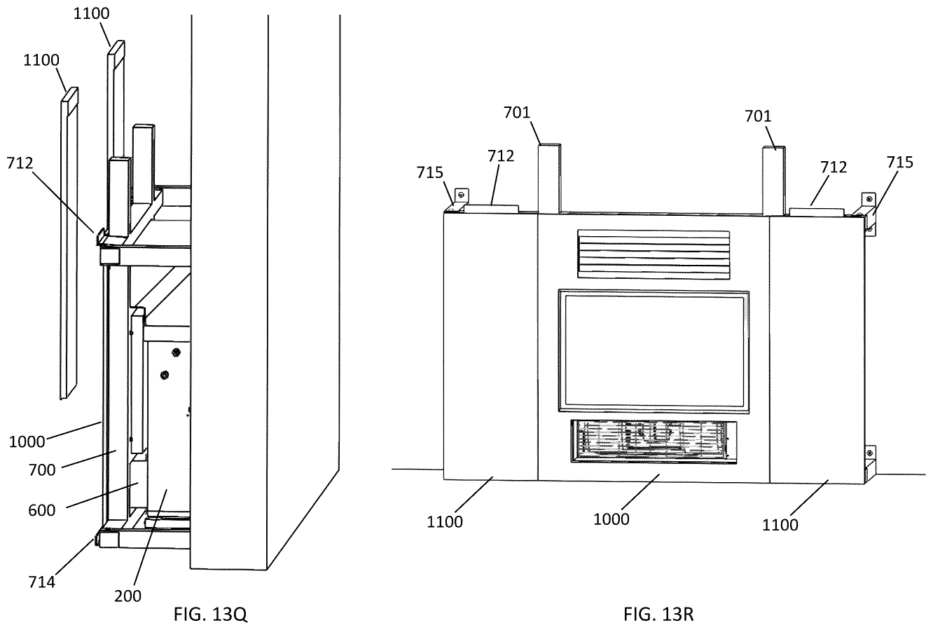

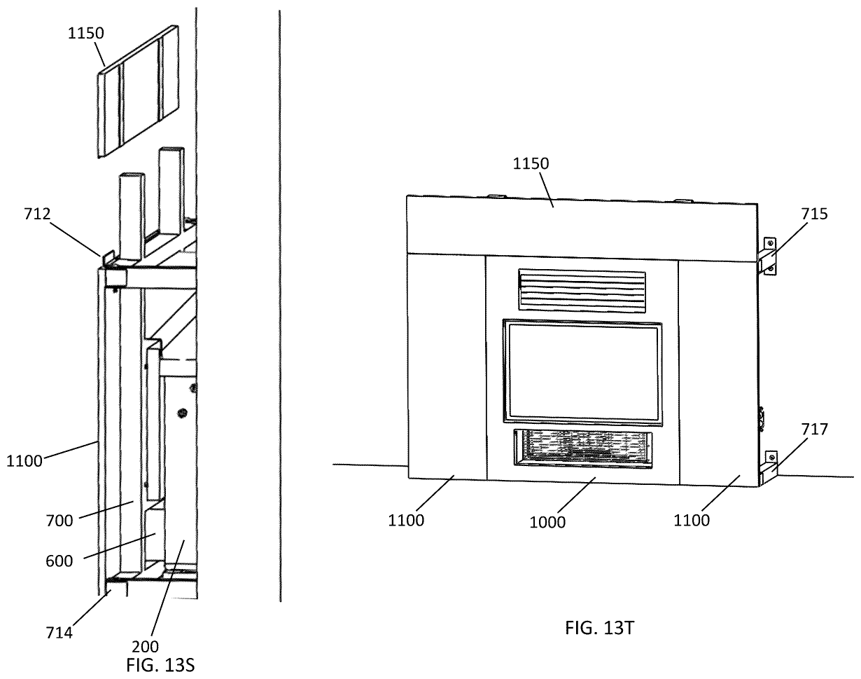

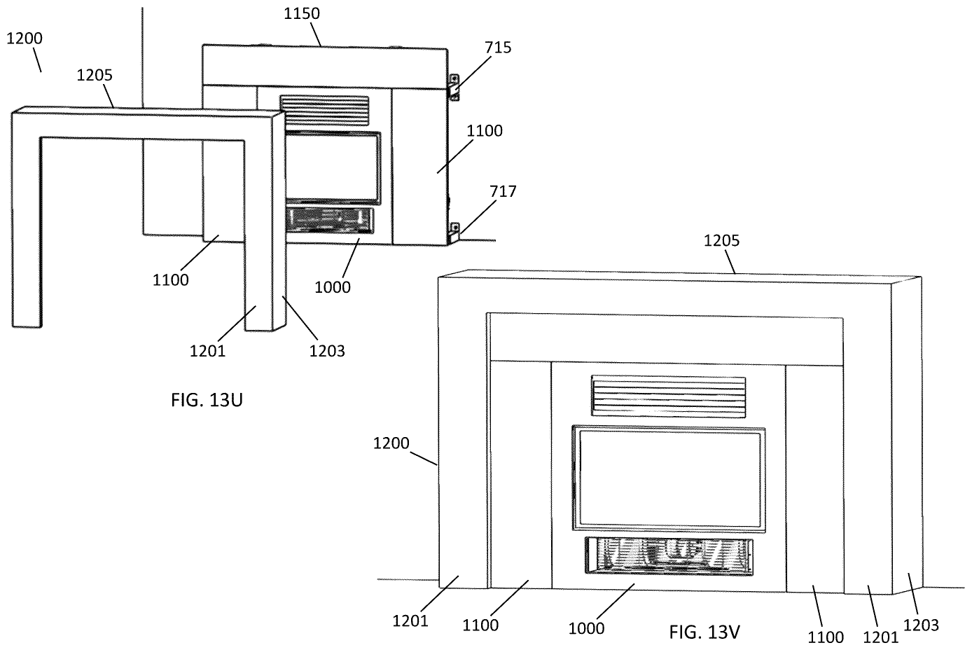

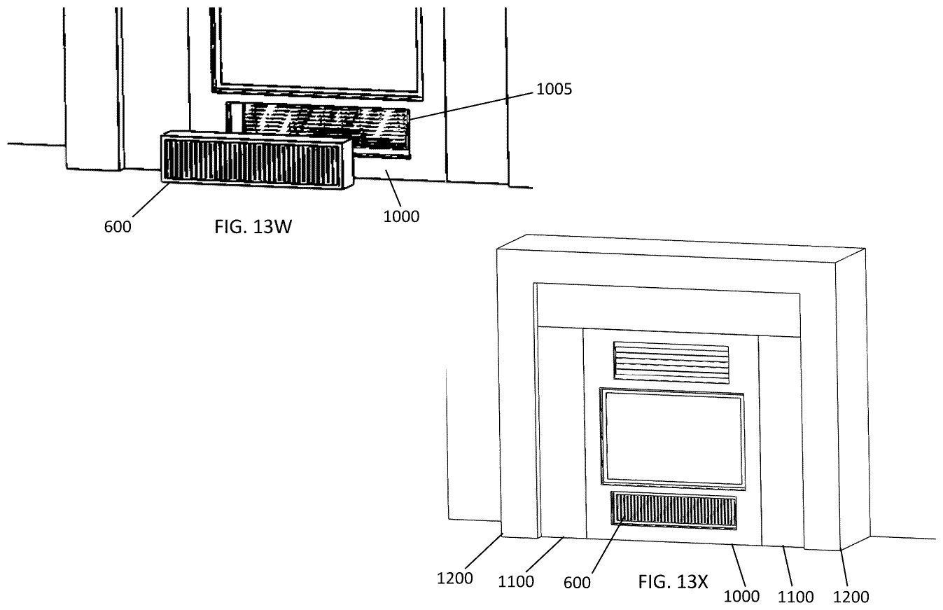

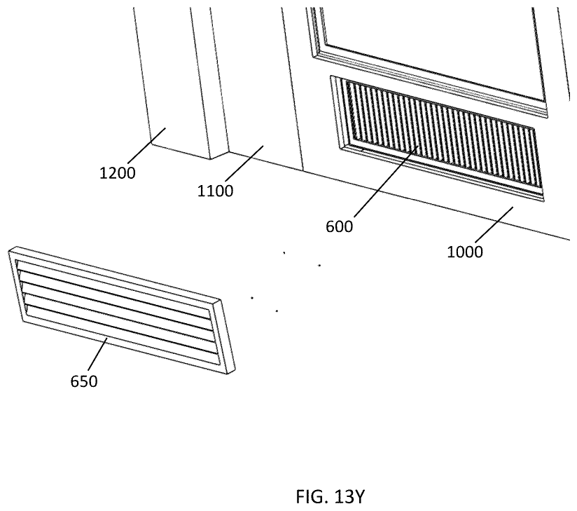

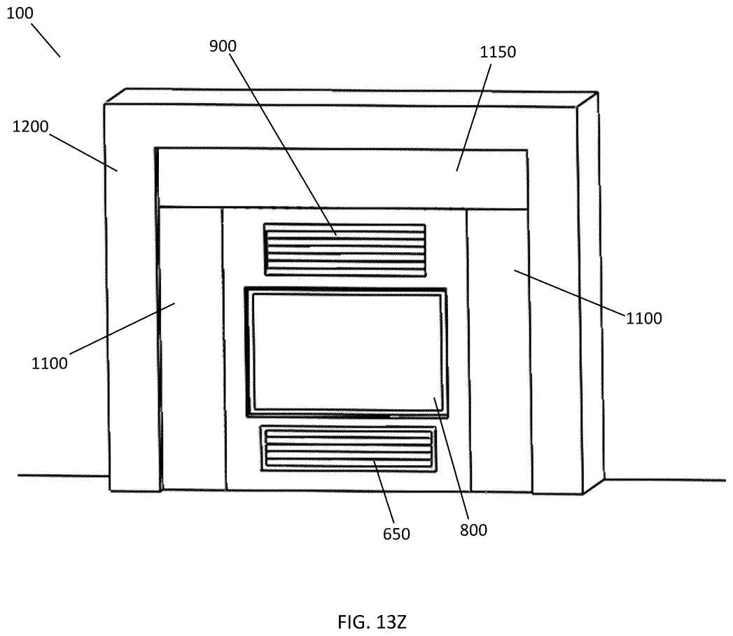

Referring now to FIGS. 13A-13Z, an installation sequence is provided as a method for installing the system 100. Because of the quick assembly design focus of the system 100, leveling of the indoor unit 200 and the floor stand 300, securing of the indoor unit 200 and the floor stand 300 to the wall by the upper and lower wall brackets 400, 450, and installation and assembly of the ornamental enclosure components (e.g., the integration frame 700, the vertical surrounds 1100, the horizontal surrounds 1150, the trim plate 1000, the flame box 800, the grill 650, and the auto louvers 900) can be performed by one person with standard household tools and does not require any special skill.

The installation of the heat pump system typically requires a heating, ventilation, refrigeration, and air conditioning (HVAC) technician and an electrician to be installed in accordance with manufacturer's directions, particularly with respect to heat pump indoor unit installation (connection to the outdoor unit). Such installation is not described herein. In general, such heat pump system installation may be performed after the indoor unit 200 and the floor stand 300 are secured to the wall by the upper and lower wall brackets 400, 450.

As shown in FIG. 13A, a first assembly step includes assembling the floor stand 300, including placement of the vibration dampeners 307 thereon, and positioning the indoor unit 200 on the floor stand 300. At this time, the floor stand 300 can be leveled using the levelable feet 305. Then, as shown in FIG. 13B, the upper and lower wall brackets 400, 450 can be mounted to the mounting tabs 205 of the indoor unit 200 using vibration dampening fasteners 405, 455, followed, as shown in FIGS. 13C-13E, by securing the upper and lower wall brackets 400, 450 to the wall with the indoor unit 200 oriented with the return air inlet 203 facing away from the wall into the conditioned room and the supply air outlet 201 facing upward.

As shown in FIG. 13F, next the foldable supply air elbow 500 with turning baffle 525 is assembled and attached in fluid communication with the supply air outlet 201. The connection between the supply air elbow 500 and the supply air outlet 201 should also preferably be scaled via taping or adhesives. The louver bracket 950 can then, as shown in FIGS. 13G-13H be installed in the outlet of the supply air elbow 500 and, as shown in FIGS. 13I-13J, the return air duct 600 can be mounted to the indoor unit 200 in fluid communication with the return air inlet 203.

Referring now to FIG. 13K, the integration frame 700 can be assembled, the supply air frame aperture 705 aligned with the outlet of the supply air elbow 500, the return air frame aperture 707 aligned with the return air duct 600, and then the integration frame mounted to the wall via upper and lower wall mounts 715, 717. In some embodiments, the lower arms 713 and the lower wall mounts 717 can preferably be positioned in at least partial contact with the floor for providing additional support to the integration frame 700, which bears the assembled weight of several ornamental elements.

Referring to FIGS. 13L-13N, the flame box 800 can then be inserted into the flame box frame aperture 709 and mounted to the integration frame by fastening mounting flanges 803 to the vertical posts 701 surrounding the flame box frame aperture. The electrical cord 805 of the flame box 800 can be routed through the flame box frame aperture 709 and between the integration frame 700 and the indoor unit 200, routed through one or more apertures in the integration frame 700, or between the integration frame 700 and the mounting flanges 803 for ultimate connection to an electrical power source.

As shown in FIG. 130, the auto louver 900 can then be installed in the outlet of the supply air elbow 500 through the supply air frame aperture 705 and attached to the louver bracket 950. The electrical cable 907 can then be connected to the indoor unit 200 for receiving electrical power and operational control information therefrom. The electrical cable 907 can be routed through the supply air aperture 705 and between the integration frame 700 and the indoor unit 200, routed through one or more apertures in the integration frame 700, or between the integration frame 700 and the flange 905 of the auto louver 900 for ultimate connection to the indoor unit 200.

Referring now to FIG. 13P, as shown, the trim plate 1000 can be slid or otherwise positioned for insertion of the trim plate tabs 718 of the integration frame 700 therein. Then, if applicable, the trim plate 1000 can be pressed or brought into contact with the integration frame 700 for engagement of other quick attachment features such as, for example, magnets, hook and loop fasteners, detents, clips, etc. Upon assembly, the trim plate 1000 is positioned in a manner that aligns the supply air trim aperture 705 with the outlet of the supply air elbow 500, the return air trim aperture 707 with the return air duct 600, and the flame box trim aperture 1007 with the flame box 800, particularly with the flame display 801.

Referring now to FIGS. 13Q-13R, as shown, the vertical surrounds 1100, on either side of the trim plate 1000, can be slid or otherwise positioned for insertion of the vertical surround tabs 714 of the integration frame 700 therein. Then, if applicable, the vertical surrounds 1100 can be pressed or brought into contact with the integration frame 700 for engagement of other quick attachment features such as, for example, magnets, hook and loop fasteners, detents, clips, etc.

Similarly, referring now to FIGS. 13S-13T, as shown, the horizontal surround 1150, across the tops of the trim plate 1000 and the adjoining vertical surrounds 1100, can be slid or otherwise positioned for insertion of the horizontal surround tabs 712 of the integration frame 700 therein. Then, if applicable, the horizontal surround 1150 can be pressed or brought into contact with the integration frame 700 for engagement of other quick attachment features such as, for example, magnets, hook and loop fasteners, detents, clips, etc.

As noted hereinabove, although described and shown herein as including one or more trim plate tabs 718, vertical surround tabs 714, and/or horizontal surround tabs 712, it will be apparent in view of this disclosure that, in some embodiments, the integration frame 700 may not include any tabs and instead may rely exclusively on quick attachment features such as those discussed herein above for the assembly of the trim plate 1000, the vertical surrounds 1100, and/or the horizontal surround 1150.

As shown in FIGS. 13U-13V, the fireplace cabinet 1200 can be slid over the rest of the assembly and preferably attached to the wall to provide a pleasing ornamental appearance of the system 100. Finally, as shown in FIGS. 13Y-13Z, the filter 625 can be inserted through the return air frame and trim apertures 707, 1005 and into the return air duct 600 and the magnetic grill attached to the trim plate 1000 to cover the return air trim aperture 1005 to complete assembly of the system 100.

While example embodiments have been particularly shown and described, it will be understood by those skilled in the art that various changes in form and details may be made therein without departing from the scope of the embodiments encompassed or contemplated herein.

As used herein, “consisting essentially of” allows the inclusion of materials or steps that do not materially affect the basic and novel characteristics of the claim. Any recitation herein of the term “comprising”, particularly in a description of components of a composition or in a description of elements of a device, can be exchanged with “consisting essentially of” or “consisting of”.

1. A heat pump air purification system comprising:
a slim duct indoor unit heat exchanger (indoor unit) positioned vertically, wherein a supply air outlet of the indoor unit is positioned above a return air inlet of the indoor unit;
a floor stand positioned underneath the indoor unit in contact with a floor;
upper and lower wall brackets attachable to one or more mounting tabs of the indoor unit and to a wall;
a supply air elbow in fluid communication with the supply air outlet and positioned to redirect a supply airflow exiting the supply air outlet;
an auto louver in fluid communication with the elbow for steering a directionality of the supply airflow exiting the heat pump air purification system;
a return air duct in fluid communication with the return air inlet;
an air filter positioned in the return air duct for filtering a return airflow;
an integration frame including:
first and second vertical posts;
a plurality of horizontal supports extending between the vertical posts and, with the vertical posts, defining a supply air frame aperture, a return air frame aperture, and a flame box frame aperture;
horizontally opposed upper and lower arms extending outward in parallel from each of the vertical posts;
upper and lower wall mounts for securing the integration frame to the wall;
a flame box mountable to the integration frame;
a trim plate including a supply air trim aperture, a return air trim aperture, and a flame box trim aperture, the trim plate removably attachable to a front surface of the integration frame;
first and second decorative vertical surround elements attachable to the front surface of the integration frame;
a horizontal surround element attachable to the front surface of the integration frame; and
a fireplace cabinet having a front surface sized and shaped to partially overlap a front surface of the vertical and horizontal surrounds, an upper surface extending between the front surface and the wall, and opposing side surfaces extending between the front surface and the wall.

2. The system of claim 1, further comprising a magnetic grill attachable to the trim plate positioned to at least partially cover the return air trim and frame apertures.

3. The system of claim 1, wherein the floor stand further comprises:
a stand frame comprising opposing end rails and opposing side rails attached to the opposing end rails, the stand frame having upper and lower surfaces; and
a plurality of feet extending from the lower surface of the stand frame.

4. The system of claim 3, wherein each of the plurality of feet of the floor stand is height-adjustable with respect to the stand frame to permit leveling of the floor stand.

5. The system of claim 3, further comprising a plurality of vibration dampening pads positioned on the upper surface of the stand frame for contact with a bottom surface of the indoor unit.

6. The system of claim 1, wherein the upper and lower wall brackets each include opposing wall attachment slots to permit variable horizontal positioning of one or more fasteners used to attach the brackets to the wall.

7. The system of claim 1, further comprising vibration dampening fasteners for attachment of the upper and lower wall brackets to the one or more mounting tabs of the indoor unit.

8. The system of claim 1, wherein the lower wall bracket further comprises a floor stand attachment tab for attachment to the floor stand.

9. The system of claim 1, wherein the upper and lower wall mounts are hingedly attached to the horizontally opposed upper and lower arms of the integration frame.

10. The system of claim 1, wherein the air filter further comprises a filter frame and a pleated filter media positioned in the filter frame.

11. The system of claim 1, wherein a pressure drop of the air filter is 0.25 in WC or less.

12. The system of claim 1, further comprising a turning baffle positioned inside the supply air elbow to redirect the supply airflow exiting the supply air outlet.

13. The system of claim 1, the auto louver including a plurality of movable vanes configured to steer at least one of a vertical directionality of the supply airflow, a horizontal directionality of the supply airflow, or combinations thereof.

14. The system of claim 1, wherein the flame box is an LED display.

15. The system of claim 1, wherein the integration frame includes at least one quick attachment mechanism for removably attaching one or more of the trim plate, the vertical surrounds, and the horizontal surround, the quick attachment mechanism including one or more of tabs, magnets, hook and loop fasteners, detents, clips, or combinations thereof.

16. The system of claim 15, wherein the integration frame includes at least one trim tab sized and shaped to engage and removably attach to the trim plate.

17. The system of claim 1, wherein a rear surface the trim plate and at least one of the front surface of the integration frame or flanges of the flame box include at least one quick attachment mechanism including one or more of magnets, hook and loop fasteners, detents, clips, or combinations thereof for attachment of the trim plate to the integration frame and/or the flanges of the flame box.

18. The system of claim 1, wherein the horizontally opposed upper and lower arms of the integration frame each include at least one vertical surround tab sized and shaped to engage and removably attach to a corresponding one of the vertical surround elements.

19. The system of claim 1, wherein a rear surface of each vertical and/or horizontal surround element and the front surface of the integration frame include at least one quick attachment mechanism including one or more of magnets, hook and loop fasteners, detents, clips, or combinations thereof for attachment of the vertical and/or horizontal surround elements to the integration frame.

20. The system of claim 1, wherein the horizontally opposed upper arms of the integration frame and/or the vertical posts of the integration frame include at least one horizontal surround tab sized and shaped to engage and removably attach to the horizontal surround element.

21. A foldable duct elbow comprising:
first and second rectangular outer elbow wall elements foldably attached along a shared side and having opposing non-shared sides;
four side elbow wall elements, each having a long end foldably attached to and coextensive with an end of one of the first and second outer elbow wall elements, a short end opposite the long end, an angled side extending from a corner of the attached outer elbow wall element on the shared side toward the short side of the side elbow wall element, and a straight side extending from a non-shared corner along the non-shared side of the attached outer elbow wall element;
a first rectangular inner elbow wall element having an attached end foldably attached to the short side of a first one of the side elbow wall elements, wherein the first one of the side elbow wall elements is attached to a first end of the first rectangular outer elbow wall element;
a second rectangular inner elbow wall element having an attached end foldably attached to the short side of a second one of the side elbow wall elements, wherein the second one of the side elbow wall elements is attached to a first end of the second rectangular outer elbow wall element such that the first and second inner elbow wall elements are positioned coextensively, spaced apart, and in parallel;
wherein folding the first inner elbow wall element along the attached end, folding the first inner elbow wall element along the long end, and folding a third side elbow wall element along the long end attached to a second end of the first rectangular outer wall element brings a free end of the first inner elbow wall element into contact with the short side of the third side elbow wall element for attachment thereto to form a first flowpath;
wherein folding the second inner elbow wall element along the attached end, folding the second inner elbow wall element along the long end, and folding a fourth side elbow wall element along the long end attached to a second end of the second rectangular outer wall element brings a free end of the second inner elbow wall element into contact with the short side of the fourth side elbow wall element for attachment thereto to form a second flowpath;
wherein the first and second flowpaths are foldable along the shared side of the first and second rectangular outer elbow wall elements to bring the angled sides of the first and second side elbow wall elements into contact, the angled sides of the third and fourth side elbow wall elements into contact, and inner sides of the first and second inner elbow wall elements into contact for attachment therebetween to form a folded configuration of the foldable duct elbow.

22. The foldable duct elbow of claim 21, wherein the shared side, each of the long ends, each of the short ends, each of the attached ends, each of the free ends, and each of the inner sides includes an angled chamfer to restrict geometry of the folded configuration to a desired shape of the foldable duct elbow.

23. The foldable duct elbow of claim 21, further comprising a turning baffle attached within the foldable duct elbow and positioned to redirect air flowing therein.

24. A method for assembling the heat pump air purification system of claim 1, comprising the steps of:
positioning the indoor unit on the floor stand;
leveling the indoor unit by adjusting leveling legs of the floor stand;
attaching the upper and lower wall brackets to the mounting tabs of the indoor unit;
fastening the lower wall bracket to the floor stand by a floor stand attachment tab of the lower wall bracket;
attaching the upper and lower wall brackets to the wall;
connecting the supply air elbow to the supply air outlet of the indoor unit;
inserting an auto louver bracket into an outlet of the supply air elbow;
attaching the air return duct to the return air inlet of the indoor unit;
aligning the integration frame with the indoor unit, the supply air elbow outlet, and the air return duct;
mounting the integration frame to the wall;
inserting the flame box into the flame box frame aperture of the integration frame and attach the flame box to the integration frame;
inserting and attaching the auto louver to the auto louver bracket in the outlet of the supply air elbow;
electrically connecting the auto louver to the indoor unit;
sliding the trim plate onto the integration frame by inserting one or more trim tabs of the integration frame into the trim plate and pressing the trim plate against the integration frame to engage at least one quick attachment mechanism including one or more of magnets, hook and loop fasteners, detents, clips, or combinations thereof positioned on a rear surface of the trim plate and/or a front surface of the integration frame;
sliding the vertical surrounds onto the integration frame by inserting one or more vertical surround tabs of the integration frame into the vertical surrounds and pressing the vertical surrounds against the integration frame to engage at least one quick attachment mechanism including one or more of magnets, hook and loop fasteners, detents, clips, or combinations thereof positioned on a rear surface of the vertical surrounds and/or a front surface of the integration frame;
sliding the horizontal surround onto the integration frame by inserting one or more horizontal surround tabs of the integration frame into the horizontal surround and pressing the horizontal surround against the integration frame to engage at least one quick attachment mechanism including one or more of magnets, hook and loop fasteners, detents, clips, or combinations thereof positioned on a rear surface of the horizontal surround and/or a front surface of the integration frame;
positioning the fireplace cabinet around the integration frame and the vertical and horizontal surrounds and attach the fireplace cabinet to the wall;
inserting the air filter into the return air duct; and
covering the air filter with a magnetic grill inserted through the return air frame and trim apertures.
